(19) United States
(12) Patent Application Publication
(10) Pub. No.: US 2022/0196955 A1
(43) Pub. Date: Jun. 23, 2022

(54) OPTICAL FIBER SPICE TRAY ORGANIZER

(71) Applicant: COMMSCOPE TECHNOLOGIES LLC, Hickory, NC (US)

(72) Inventors: Bart Mattie CLAESSENS, Hasselt (BE); Philippe COENEGRACHT, Hasselt (BE); Johan GEENS, Bunsbeek (BE); Pieter VERMEULEN, Westerlo (BE)

(73) Assignee: COMMSCOPE TECHNOLOGIES LLC, Hickory, NC (US)

(21) Appl. No.: 17/599,942

(22) PCT Filed: Mar. 27, 2020
(86) PCT No.: PCT/US2020/025352

§ 371 Date: Sep. 29, 2021

Related U.S. Application Data
(60) Provisional application No. 62/826,697, filed on Mar. 29, 2019.
(60) Provisional application No. 62/876,518, filed on Jul. 19, 2019.

(51) Int. Cl. G02B 6/44

(52) U.S. Cl. CPC G02B 6/4454; G02B 6/4452

(57) ABSTRACT

A telecommunication component includes a cover that is sized and shaped to cover a stack area having an outer boundary. The telecommunication component includes a stack that includes a plurality of optical fiber splice trays pivotally connected to a tray support. The stack is movable between a stored position and an access position. When the stack is in the stored position, the plurality of optical fiber splice trays is positioned within the outer boundary of the stack area. When the stack is in the access position, at least one of the plurality of optical fiber splice trays is positioned at least partially outside of the outer boundary of the stack area.

### CROSS-REFERENCE TO RELATED APPLICATIONS

This application is being filed on Mar. 27, 2020 as a PCT International Patent Application and claims the benefit of U.S. Patent Application Ser. No. 62/826,697, filed on Mar. 29, 2019, and claims the benefit of U.S. Patent Application Ser. No. 62/876,518, filed on Jul. 19, 2019, the disclosures of which are incorporated herein by reference in their entireties. The following disclosures are also incorporated herein by reference in their entireties: U.S. Patent Application Ser. No. 62/826,686, filed on Mar. 29, 2019; U.S. Patent Application Ser. No. 62/876,508, filed on Jul. 19, 2019; U.S. Patent Application Ser. No. 62/868,113, filed on Jun. 28, 2019; and U.S. Patent Application Ser. No. 62/876,498, filed on Jul. 19, 2019.

### BACKGROUND

Optical fiber splice trays having an area to store at least at one optical splice is known. Each tray is sized based on an application and can include storage space for a plurality of splices and also space for guiding organized spliced fibers. Organizing the trays in a stack is common so that each tray can be separately accessed. Further, each tray can be attached to a hinge to allow the technician to move each tray, or a series of trays, out of the way to allow a tray located lower in the stack to be accessed. Improvements in optical fiber splice storage is needed.

### SUMMARY

The present invention relates to the management of optical fiber trays. In certain examples, optical fiber trays are organized in a stack so that the stack, as a whole, can be moved between a stored position, where the trays are vertically aligned, and an access position, where the trays are staggered. When in the stored position, a cover can be secured over the stack of optical fiber trays so as to enclose a telecommunication component containing the stack. When in the access position, a cover cannot be secured over the stack of optical fiber trays.

In one aspect of the present disclosure, a telecommunication component is disclosed. The telecommunication component includes a cover that is sized and shaped to cover a stack area having an outer boundary. The telecommunication component includes a stack that includes a plurality of optical fiber splice trays pivotally connected to a tray support. The tray support is hingedly connected to a base. The stack is movable by the tray support between a stored position and an access position. When the stack is in the stored position, the plurality of optical fiber splice trays is positioned within the outer boundary of the stack area. When the stack is in the access position, at least one of the plurality of optical fiber splice trays is positioned at least partially outside of the outer boundary of the stack area.

In some examples, the tray support includes at least one groove plate removably secured thereto.

In some examples, at least one of the tray support and a base includes a stop, wherein the stop is configured to interface with the corresponding tray support and base to limit further rotation of the tray support past the access position.

In some examples, the component includes a latch, wherein the latch secures the tray support in at least one of the stored position and the access position.

In some examples, the plurality of optical fiber splice trays of the stack contain differently sized trays.

In some examples, the plurality of optical fiber splice trays of the stack contain identically sized trays.

In some examples, when in the access position, the plurality of optical fiber splice trays of the stack are positioned in a staggered configuration.

In some examples, when in the stored position, the plurality of optical fiber splice trays of the stack are positioned in a vertically aligned configuration.

In some examples, the tray support is modular.

In some examples, the base is a base plate attached to a closure base.

In some examples, the base includes at least one fiber radius limitation channel adjacent a hinge configured to receive the tray support.

In some examples, the at least one fiber radius limitation channel is adjacent a hinge, the hinge being configured to receive the tray support.

In some examples, the at least one fiber radius limitation channel is an arced channel that extends away from the hinge, wherein the at least one fiber radius limitation channel is configured to house optical fibers that travel to and from the plurality of optical fiber splice trays and the base.

In some examples, the base includes at least one splitter storage location that is configured to store an optical fiber splitter.

In another aspect of the present disclosure, a method of operating a telecommunications system is disclosed. The method includes providing a cover removably attached to a base and providing a tray support rotatably fixed about a hinge to the base. The tray support is movable between a stored position and an access position. The method includes providing a plurality of optical fiber splice trays rotatably connected to the tray support. When the tray support is in the stored position, the optical fiber splice trays occupy a stack area defined by an outer boundary. The method includes removing the cover from the base. The method includes moving the tray support to the access position after removing the cover. When in the access position, at least one of the plurality of optical fiber splice trays is positioned at least partially outside of the outer boundary of the stack area.

In some examples, the tray support is in the stored position, the plurality of optical fiber splice trays are in an aligned stacked arrangement.

In some examples, when the tray support is in the access position, the plurality of optical fiber splice trays are in a staggered stacked arrangement.

In some examples, when moving the tray support to the access position, the tray support is moved away from the base.

In some examples, when the tray support is moved to the access position, pivoting at least one of the plurality of optical fiber splice trays with respect to the tray support.

In another aspect of the present disclosure, a telecommunication component includes a base including a hinge, a stack including a plurality of optical fiber splice trays pivotally connected to a tray support, the tray support being connected to base via the hinge, wherein the stack is movable between a stored position and an access position, wherein, when the stack is in the stored position, the plurality of optical fiber splice trays is positioned within the outer boundary of the stack area, and wherein, when the stack is in the access position, at least one of the plurality of optical fiber splice trays is positioned at least partially outside of the outer boundary of the stack area.

In one aspect of the present disclosure, a toolless interface for connecting telecommunications components is disclosed. The interface includes a first body that includes at least one of a plurality of recesses and a plurality of projections. The first body includes a stop surface. The interface includes a second body including the corresponding other of the at least one of a plurality of recesses and plurality of projections. The second body includes a stop structure. Each of the plurality of projections includes a guiding portion and a holding portion and each of the plurality of recesses is configured to receive a projection of the plurality of projections. Each of the plurality of recesses has a length and a width. Each recess includes a first portion that has a width corresponding to the holding portion of the projection of the plurality of projections, and a second portion that has a width corresponding to the guiding portion of the projection of the plurality of projections. The width of the first portion is greater than the width of the second portion. The stop structure and the stop surface are configured to mate with one another to limit relative movement between of the plurality of projections and the plurality of recesses.

In some examples, the guiding portion extends along a length, the guiding portion having a first end and a second end, wherein the holding portion is positioned at the first end of the guiding portion, and wherein the holding portion extends a greater distance away from at least one of the first body and the second body that includes the plurality of projections than the guiding portion.

In some examples, the holding portion of each projection has a width that is greater than a width of the guiding portion.

In some examples, the length of each guiding portion defines a sliding direction, wherein the stop structure and stop surface are positioned aligned with the sliding direction.

In some examples, the first body further includes a stop aperture adjacent to, and separate from, the stop surface, wherein the stop aperture is configured to temporality receive the stop structure of the second body.

In some examples, the stop aperture receives the stop structure until the first body is moved in the sliding direction so that the stop structure is removed from the stop aperture and mates with the stop surface of the first body.

In some examples, the stop structure is a flexible tab.

In some examples, the guiding portion is a fin.

In some examples, the holding portion is a sphere.

In some examples, the plurality of projections is at least two projections.

In some examples, the plurality of projections is at least four projections.

In some examples, the first body includes an attachment feature for receiving a telecommunications component, wherein the attachment features includes at least one deflectable member disposed within a recessed area of the first body facing the second body, wherein the deflectable member can deflect towards the second body when the first and second bodies are connected to each other via the plurality of recesses and projections.

In another aspect of the present disclosure, a telecommunications component is disclosed. The telecommunications component includes a main body and a plurality of projections extending from the main body. The plurality of projections are configured to attach the main body to a mating structure. The plurality of projections each include a guiding portion and a holding portion. The guiding portion extends along a length and has a first end and a second end. The holding portion is positioned at the first end of the guiding portion, and the holding portion extends at a greater distance away from the main body than the guiding portion.

In some examples, the holding portion has a width that is greater than a width of the guiding portion at the second end.

In some examples, the length of each guiding portion defines a sliding direction, wherein the main body further includes a stop surface configured to mate with a stop structure of the mating structure, wherein the stop surface and stop structure limit relative movement of the main body and the mating structure.

In some examples, the main body further includes a stop aperture adjacent to, and separate from, the stop surface, and wherein the stop aperture is configured to temporality receive the stop structure of the mating structure.

In some examples, the stop aperture receives the stop structure in a non-fixed position until the main body is moved in the sliding direction toward a fixed position, wherein, when in the fixed position, the stop structure is removed from the stop aperture and mated with the stop surface of the main body.

In some examples, the stop structure is a flexible tab.

In another aspect of the present disclosure, a toolless interface for connecting telecommunications components is disclosed and can include a first body including at least one of a plurality of recesses and a plurality of projections, the first body including a stop surface, a second body including the corresponding other of the at least one of a plurality of recesses and plurality of projections, wherein each of the plurality of recesses is configured to receive a projection of the plurality of projections such that the first body and second body can be connected to each other, and an attachment feature for receiving a telecommunications component, wherein the attachment features includes at least one deflectable member disposed within a recessed area of the first body facing the second body, wherein the deflectable member can deflect towards the second body when the first and second bodies are connected to each other via the plurality of recesses and projections.

In some examples, the attachment feature includes a plurality of deflectable members.

In some examples, a first wall of the first body is adjacent a second wall of the second body when the first and second bodies are connected to each other, wherein the at least one deflectable member is recessed within the first wall and spaced away from the second wall.

In another aspect of the present disclosure, a method of connecting a telecommunications system is disclosed. The method includes providing a first body that includes at least one of a plurality of recesses and a plurality of projections. The first body includes a stop surface. The method includes providing a second body that includes the corresponding other of the at least one of a plurality of recesses and the plurality of projections. The second body includes a stop structure. Each of the plurality of projections includes a guiding portion and a holding portion and each of the plurality of recesses is configured to receive a projection of the plurality of projections. Each of the plurality of recesses has a length and a width, and each recess includes a first portion having a width corresponding to the holding portion of the projection of the plurality of projections, and a second portion having a width corresponding to the guiding portion of the projection of the plurality of projections. The width of the first portion is greater than the width of the second portion. The method includes inserting the plurality of projections into the plurality of recesses. The method includes moving the first and the second bodies relative to one another so that the plurality of projections move within the plurality of recesses. The movement mates the stop structure and the stop surface with one another to limit relative movement between of the plurality of projections and the plurality of recesses.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a perspective view of a telecommunications closure, according to one example of the present disclosure.

FIG. 2 is a perspective view of the telecommunications closure of FIG. 1 with a cover removed.

FIG. 3 is a top perspective view of a base plate of the stack of FIG. 1 without optical fiber splice trays installed on a base tray, according to one example of the present disclosure.

FIG. 4 is a bottom perspective view of the base plate of the stack of FIG. 1 installed on the base tray.

FIG. 5 is a perspective view of a stack of optical fiber splice trays in a stored position, according to one example of the present disclosure.

FIG. 6 is a perspective view of the stack of optical fiber splice trays of FIG. 5 in an access position.

FIG. 7 is a side view of the stack of optical fiber splice trays of FIG. 5 in the stored position.

FIG. 8 is a side view of the stack of optical fiber splice trays of FIG. 5 in the access position.

FIG. 9 is a side view of the stack of optical fiber splice trays of FIG. 5 in the access position with the top tray in a raised position.

FIG. 10 is a rear perspective view of the stack of optical fiber splice trays of FIG. 5 in the stored position.

FIG. 11 is an exploded perspective view of the stack, a base tray, a base plate, and the optical fiber splice trays of FIG. 5.

FIG. 12 is a top perspective view of a main support plate of a tray support, according to one example of the present disclosure.

FIG. 13 is a bottom perspective view of the main support plate of the tray support of FIG. 12.

FIG. 14 is an exploded perspective view of the main support plate of the tray support of FIG. 12.

FIG. 15 is a bottom perspective view of the main support plate of the tray support of FIG. 12.

FIG. 16 is a top perspective view of an auxiliary support plate of the tray support of FIG. 12, according to one example of the present disclosure.

FIG. 17 is a bottom perspective view of the auxiliary support plate of the tray support of FIG. 12.

FIG. 18 is a top view of the base tray of FIG. 11, according to one example of the present disclosure.

FIG. 19 is a bottom view of the base tray of FIG. 11, according to one example of the present disclosure.

FIG. 20 is a top front perspective view of a base plate, according to one example of the present disclosure.

FIG. 21 is a rear perspective view of the base plate of FIG. 20.

FIG. 22 is a bottom perspective view of the base plate of FIG. 20.

FIG. 23 is a top view of the base plate of FIG. 20.

FIG. 24 is a bottom view of the base plate of FIG. 20.

FIG. 25 is a side view of the base plate of FIG. 20.

FIG. 26 is an end view of the base plate of FIG. 20.

FIG. 27 is a perspective view of a latch of a tray support and base plate, according to one example of the present disclosure.

FIG. 28 is a zoomed in view of the latch of FIG. 27.

FIG. 29 is a partial exploded view of the tray support of FIG. 27.

FIG. 30 is a partial exploded view of the stack of optical fiber splice trays, base tray, and base plate of FIG. 5 separated from a base tray.

FIG. 31 is a bottom perspective view of the base tray and the base plate of FIG. 30 in a non-fixed position.

FIG. 32 is a zoomed-in portion of FIG. 31.

FIG. 33 is a bottom perspective view of the base tray and the base plate of FIG. 30 in a fixed position.

FIG. 34 is a zoomed-in portion of FIG. 33.

FIG. 35 is a top view of the base tray and the base plate of FIG. 30 in the non-fixed position.

FIG. 36 is a top view of the base tray and the base plate of FIG. 30 in the fixed position.

FIG. 37 is a perspective view of a stack of optical fiber splice trays attached to a module, according to one example of the present disclosure.

FIG. 38 is a bottom perspective view of the stack of optical fiber splice trays and module of FIG. 37.

FIG. 39 is a partial exploded view of the stack of optical fiber splice trays and module of FIG. 37.

FIG. 40 is a perspective view of the stack of optical fiber splice trays and module of FIG. 37 without trays.

FIG. 41 is a perspective view of the module of FIG. 37 without trays, a patch panel, or groove plates.

FIG. 42 is a bottom perspective view of the module of FIG. 37 without trays, a patch panel, or groove plates.

FIG. 43 is a top view of the module of FIG. 37.

FIG. 44 is a bottom view of the module of FIG. 37.

FIG. 45 is a front view of the module of FIG. 37.

FIG. 46 is a rear view of the module of FIG. 37.

FIG. 47 is a side view of the module of FIG. 37.

FIG. 48 is another side view of the module of FIG. 37.

FIG. 49 is a perspective view of a module connected to a base tray, according to one example of the present disclosure.

FIG. 50 is a bottom perspective view of the module and the base tray of FIG. 49.

FIG. 51 is a partial exploded view of the module and the base tray of FIG. 49.

FIG. 52 is a top view of the module of FIG. 49.

FIG. 53 is a bottom view of the module of FIG. 49.

FIG. 54 is a front view of the module of FIG. 49.

FIG. 55 is a rear view of the module of FIG. 49.

FIG. 56 is a side view of the module of FIG. 49.

FIG. 57 is another side view of the module of FIG. 49.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

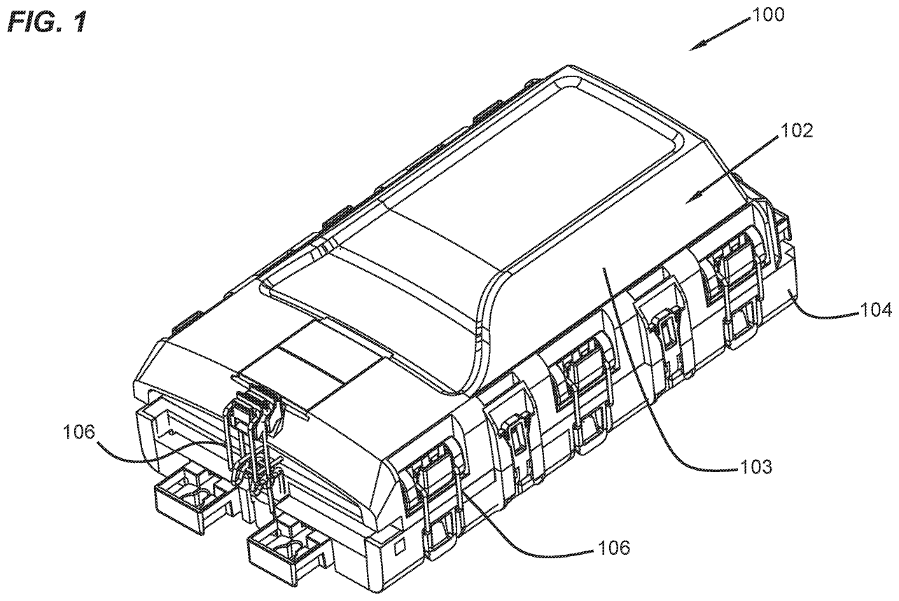

FIG. 1 illustrates an example closure 100. In the depicted example, the closure 100 is a telecommunications closure configured to house telecommunications components. The closure 100 includes a cover 102 mounted to a closure base 104. In some examples, the cover 102 is secured to the base by at least one closure latch 106. In some examples, the cover includes a stack portion 103.

The cover 102 can have a variety of different configurations. In some examples, the stack portion 103 is a domed portion of the cover 102. In some examples, the cover 102 can have a larger or smaller stack portion 103 depending on the application. In some examples, the cover 102 can be interchanged with another cover of a different size and configuration. For example, a cover 102 with a larger stack portion 103 than the cover 102 that is depicted can be used for certain applications. Alternatively, a cover 102 with a smaller stack portion 103 than the cover 102 that is depicted can be used for other applications.

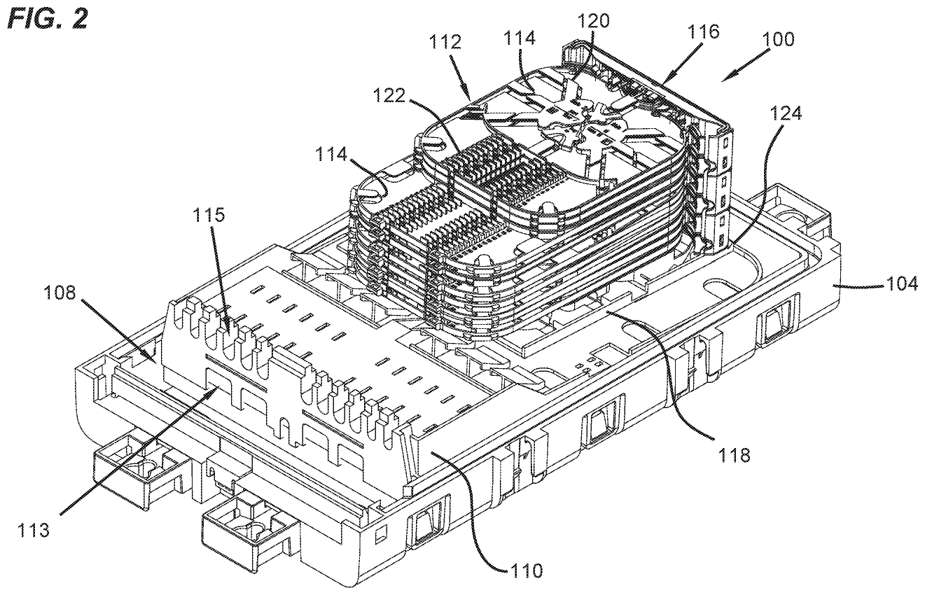

FIG. 2 shows the cover 102 removed from the closure base 104. An interior 108 of the closure 100 includes base tray 110 and an optical fiber tray stack 112. The interior 108 of the closure 100 can also contain other telecommunications components, some of which can be mounted to the base tray 110. The stack 112 includes at least one optical fiber splice tray 114, a tray support 116, and a base plate 118.

The base tray 110 is configured to be placed within the closure base 104. In some examples, the base tray 110 is configured to organize input and/or output fibers/cables that enter and leave the closure 100. In some examples, the base tray 110 is configured to organize cables. In some examples, input cables 101 (e.g., feeder/branch cables), each containing a plurality of optical fibers, are received at lower cable guides 113, and output cables 172 (i.e., drop cables) are secured to upper cable guides 115 on the base tray 110.

In the depicted example, the stack 112 includes a plurality of the optical fiber splice trays 114. In some examples, the splice trays 114 can instead be patch trays. The trays 114 of the stack 112 may be constructed identically. In some examples, the trays 114 are of differing sizes and shapes. Each tray 114 includes a fiber guide 120 and a splice storage area 122. Each tray 114 is configured to receive input fiber, sometimes a fiber from a distribution cable, and splice the input fiber to an output fiber. The output fiber travels away from the tray 114 for use elsewhere in the closure 100. Each tray 114 is pivotally connected to the tray support 116 so that each tray 114 can be rotated with respect to the other trays 114 in the stack 112.

The tray support 116 is configured to pivotally receive each tray 114. In some examples, the tray support 116 can be modular to allow for expansion or reduction of the tray support 116 to hold more or less trays 114. The tray support 116 is connected to the base plate 118 by a hinge 124. In some examples, the tray support 116 is hingedly connected to the closure base 104.

The base plate 118 is configured to be fixed to the closure base 104 via the base tray 110. In some examples, the base plate 118 is fixed to the base tray using a toolless interface. In some examples, the base plate 118 can include additional space to store optical fiber splices, splitters and additional lengths of fiber. In some examples, the base plate 118 aids to guide input/output fibers to and from the trays 114. In some examples, the base plate 118 is a patch module and is configured to facilitate connections with input fibers received from an input cable (e.g. a drop cable) with fibers a travel to each tray 114. In some examples, the base 118 can facilitate connectorized connections with each tray 114.

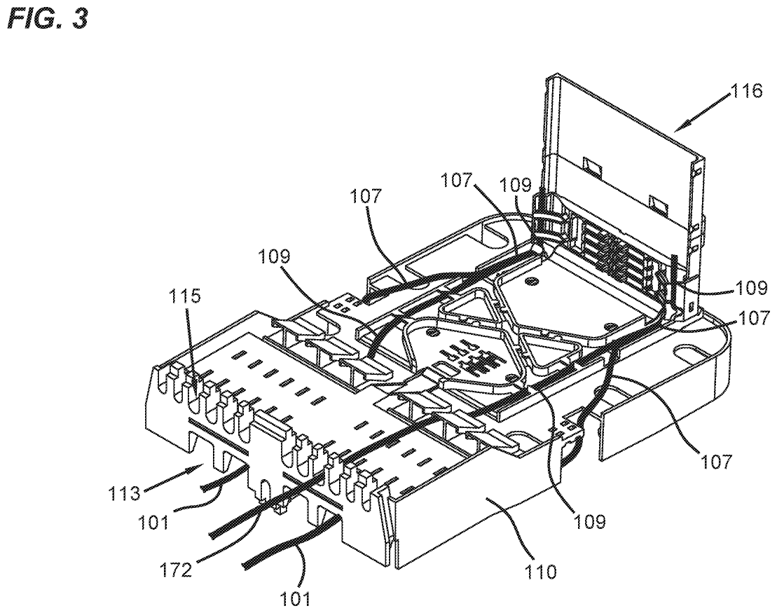

FIG. 3 shows a perspective top view of the base plate 118 attached to the base tray 110, without any trays installed on the tray support 116.

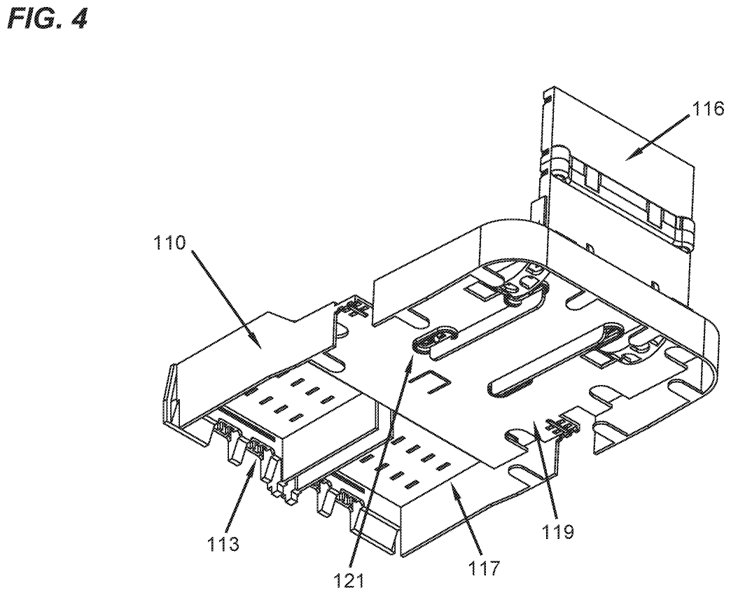

FIG. 4 shows a perspective bottom view of the base plate 118 attached to the base tray 110, without any trays installed on the tray support 116. A bottom side 117 of the base tray 110 can include a storage area 119 to store loop cables. The base tray 110 can be configured in a variety of different ways. In some examples, portions of the base plate 118 pass through the base tray 110. Further, the base tray 110 can include interfacing features 121, which will be discussed in more detail herein, that cooperate with corresponding interfacing features of the base plate 118, or other components, that aid in securing the base plate 118, or other components, to the base tray 110 without the use of tools. This is advantageous as the end user can customize the configuration of the enclosure and easily secure components to one another.

Input fibers 107 are schematically shown in FIG. 3. In some examples, the input fibers can travel from the under the base 110, into a side of the base plate 118, and up to trays 114 secured to the tray support 116. The input fibers 107 are then spliced at the tray 114 to an output fiber 109, which can then travel back down the tray support 116 to the base plate 118 along the same route the input fibers 107 take. Also, the output fibers 109 can travel down the tray support 116 on an opposite side of the tray support 116 than the side the input fiber 107 traveled up. Once the output fibers 109 reach the base plate 118, the output fibers 109 can be routed to the upper cable guides 115 for distribution outside of the closure 100. In some examples, a point-to-point connection can be facilitated. In some examples, the output fibers 109 can enter an optical fiber splitter at the base plate 118 before exiting to the upper cable guides 115 to provide a split output. In some examples, the base plate 118 can have a patch panel so that the output fiber 109 is connectorized and enters the patch panel.

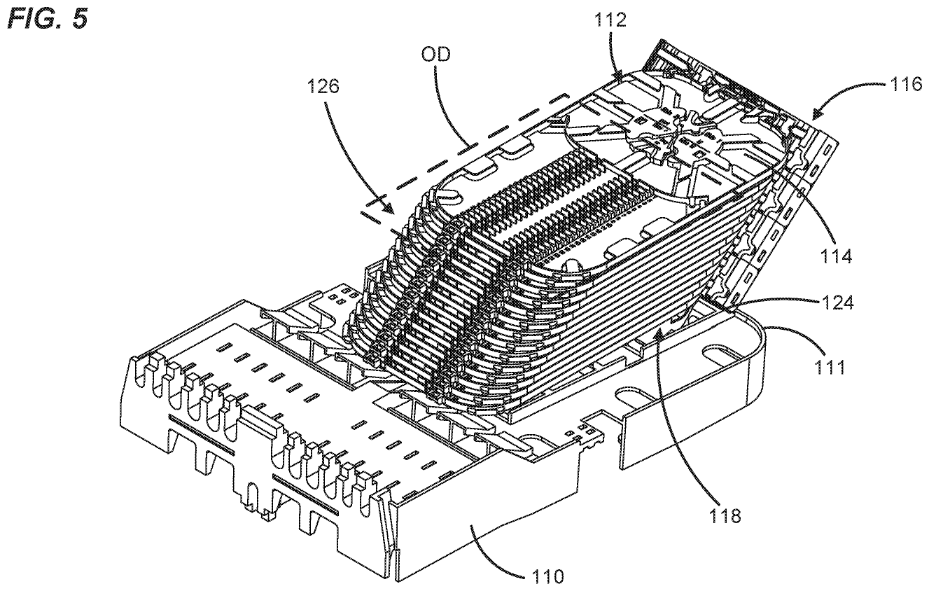

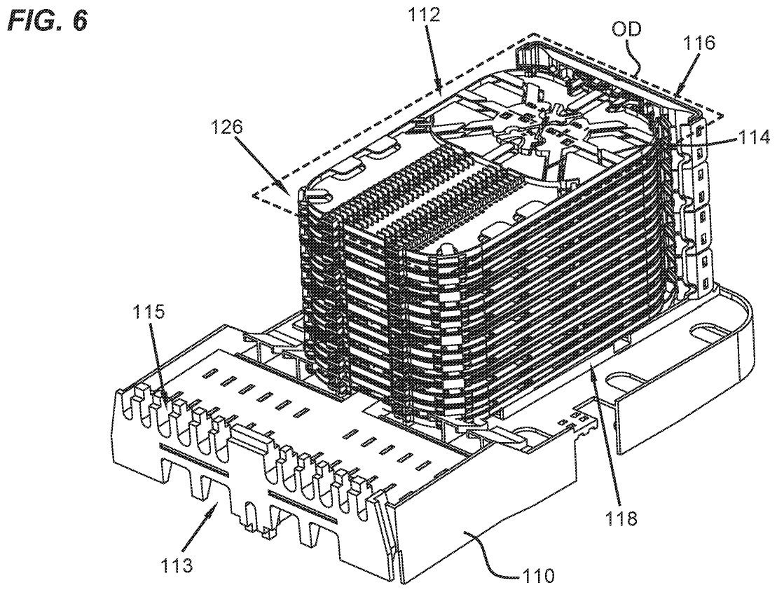

FIG. 5 shows a perspective view of the stack 112 in a stored position. FIG. 6 shows a perspective view of the stack 112 in an access position. When in the stacked position, the trays are vertically aligned. When in the access position, the trays are in a staggered configured so that the stack 112 is reclined. In some examples, when in the access position, the stack 112 is positioned at least partially past an edge 111 of the base tray 110. In the depicted example of FIGS. 5 and 6, the stack 112 includes large trays that are all identically sized.

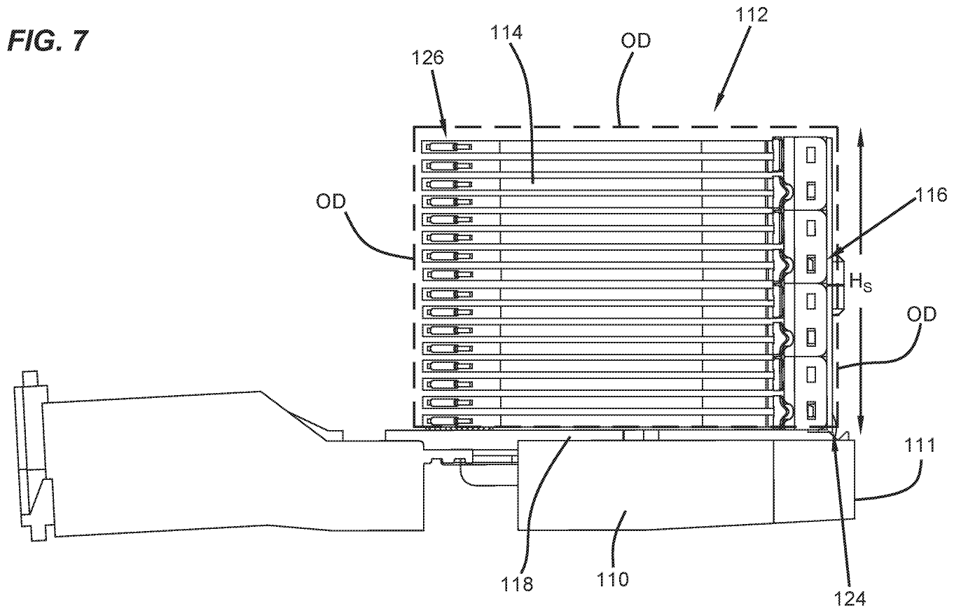

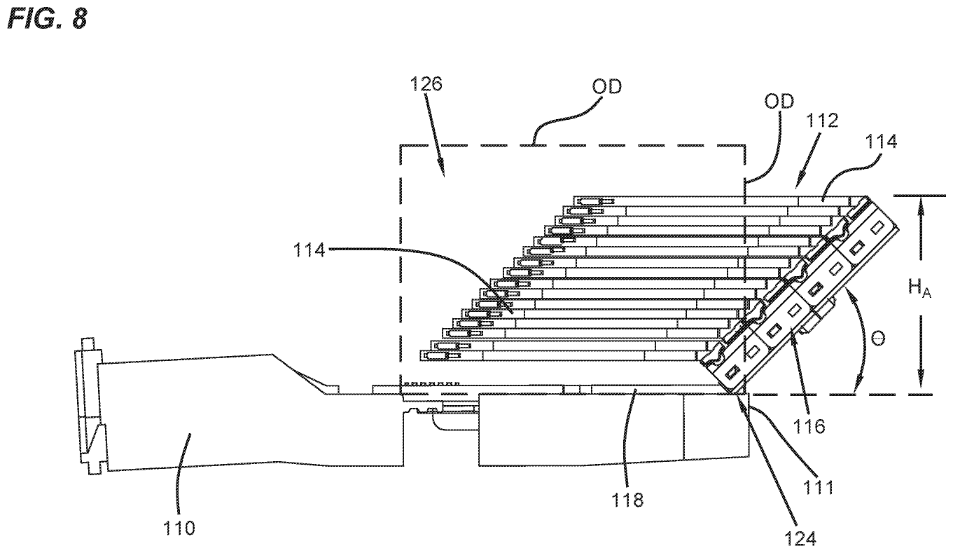

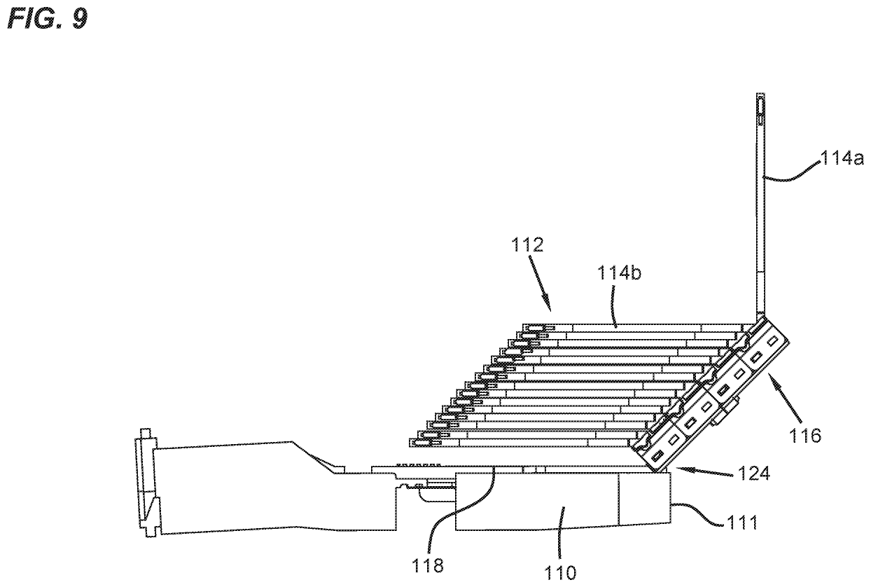

FIG. 7 shows a side view of the stack 112 in the stored position, and FIG. 8 shows a side view of the stack 112 in the access position. FIG. 9 shows a side view of the stack 112 in the access position with a single tray 114a pivoted to a raised position with respect to the tray support 116 and other trays 114 in the stack. In the raised position, the technician can gain full access to a second tray 114b of the stack 112. In the depicted example of FIGS. 7-9, the stack 112 includes small trays that are all identically sized.

In the stored position, the stack 112 occupies a stack area 126 defined by an outer boundary OD. The stack area 126, and therefore the outer boundary OD, is defined by the size of trays 114 within the stack 112 and the tray support 116. In the stored position, the trays 114 cannot be moved enough with respect to the tray support 116 to facilitate proper access the trays 114. When the stack 112 is moved to the access position, at least one of the trays 114 is positioned at least partially outside of the outer boundary OD of the stack area 126, which can be seen in FIG. 6 and FIG. 8. When in the access position, the trays 114 can be fully pivoted with respect the tray support 116 to facilitate full access to any of the trays 114. In some examples, when pivoted upward, the trays 114 are configured to stay positioned in an upward orientation. When moving from the stored position to the access position, the stack 112 is pivoted away from the base plate 118 about the hinge 124. In some examples, the tray support 116 forms an angle θ with the base plate 118. In some examples, the angle θ is less than 90 degrees. In some examples, the angle θ is about 45 degrees.

The cover 102 is sized and shaped to cover the stack area 126 when the cover 102 is attached to the closure base 104. In some examples, the stack portion 103 of the cover 102 is sized and shaped to fit over the stack 112 only when the stack 112 is in the stored position, and not when the stack 112 is in the access position.

When in the stored position, the stack 112 has a height of Hs, as seen in FIG. 7, and when in the access position, the stack has a height of Ha, as seen in FIG. 8. Because of the reclined position of the access position, the height Ha of the stack 112 in the access position is less than the height Hs of the stack 112 in the stored position.

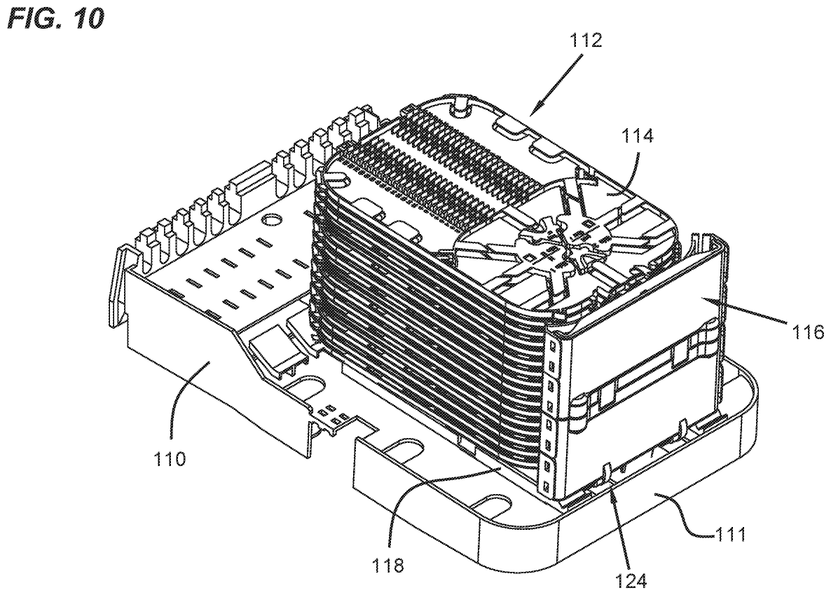

FIG. 10 shows a back perspective view of the stack 112 in the stored position attached to the base tray 110. In the depicted example, the stack 112 includes small trays that are all identically sized.

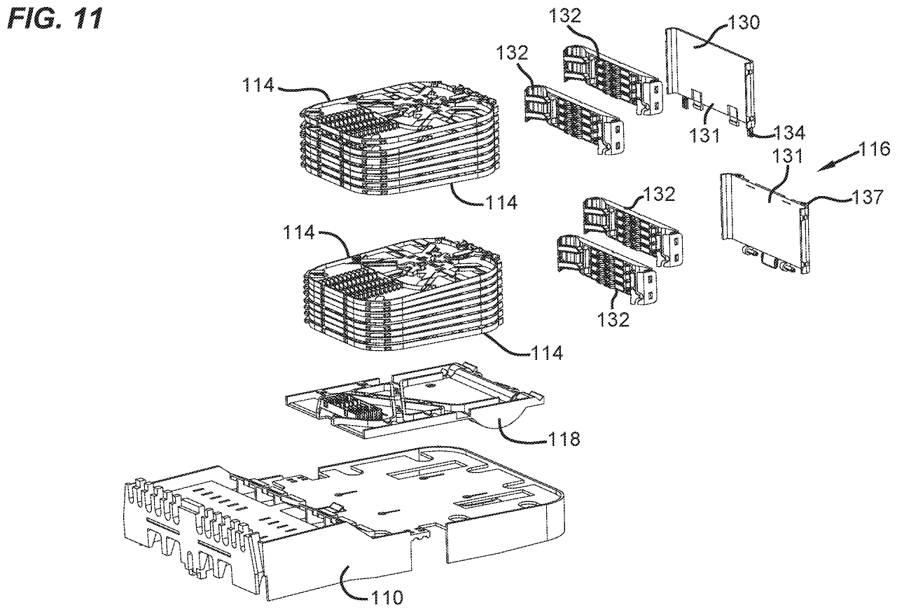

FIG. 11 shows an exploded view of the base tray 110, trays 114, tray support 116, and base plate 118.

As shown, the tray support 116 includes a main support plate 128 and an auxiliary support plate 130. The main and auxiliary support plates 128, 130 are configured to connect with one another in a stacked configuration utilizing mating features 131. In some examples, the tray support 116 can include more than one auxiliary support plate 130. In some examples, the tray support 116 can include a main support plate 128 and a plurality of auxiliary support plates 130. In the depicted example, the auxiliary support plate 130 includes at least one projection 134 that mates with at least one recess 137 of the main support plate 128. In some examples, the main and auxiliary support plates 128, 130 can be clipped together. The main and auxiliary support plates 128, 130 are configured to receive a plurality of groove plates 132 that are configured to attached to each plate 128, 130. The groove plates 132 are configured to hingedly attach the trays 114 to allow each tray to separately pivot about the groove plate 132 to which it is attached.

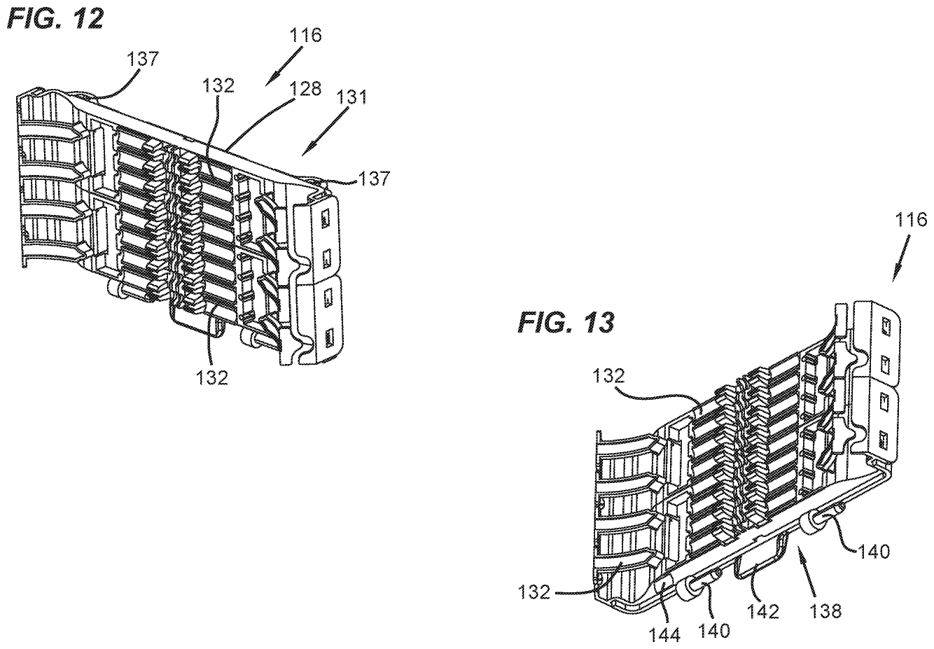

FIG. 12 shows a top perspective of the main support plate 128 including a pair of groove plates 132 secured thereto. FIG. 13 shows a bottom perspective view of the main support plate 128 including a pair of groove plates 132 secured thereto. As shown, the main support plate 128 can include mating features 131 at a top side, opposite of hinge features 138 at a bottom side. The mating features 131 include a pair of recesses 137 that are configured to receive corresponding projections of the auxiliary support plate 130. In some examples, the main support plate 128 can include projections and/or projections and recesses, or other like mating features.

The hinge features 138 at the bottom side of the main support plate 128 are configured to mate with the base plate 118 to hingedly attach the main support plate 128 with the base plate 118 at the hinge 124. In the depicted examples, the hinge features 138 of the main support plate 128 include a pair of projections 140. However, it is considered within the scope of the present disclosure that the hinge features can take the form of a variety of different features that allow hingedly attaching the main support plate 128 to the base plate 118.

In some examples, the hinge features 138 can include a stop 142. The stop 142 is configured to limit rotation of the tray support 116 to limit, and in some examples, prevent, further movement past the access position in a direction away from the base plate 118. In some examples, the stop 142 interfaces with the base plate 118 so as to hold the stack 112 in the access position. In some examples, the stop 142 may be located on the base plate 118 and operate in substantially the same manner.

In some examples, the main support plate 128 can include a portion of a latch 144, shown schematically in FIG. 13. In some examples, the latch 144 is configured to secure the main support plate 128 so that the stack 112 remains in at least one of the stored and access positions. It is considered within the scope of the present disclosure that the latch 144 can be configured in a variety of different ways to allow for the stack 112 to be secured (e.g., latched) in at least one of the stored and access positions.

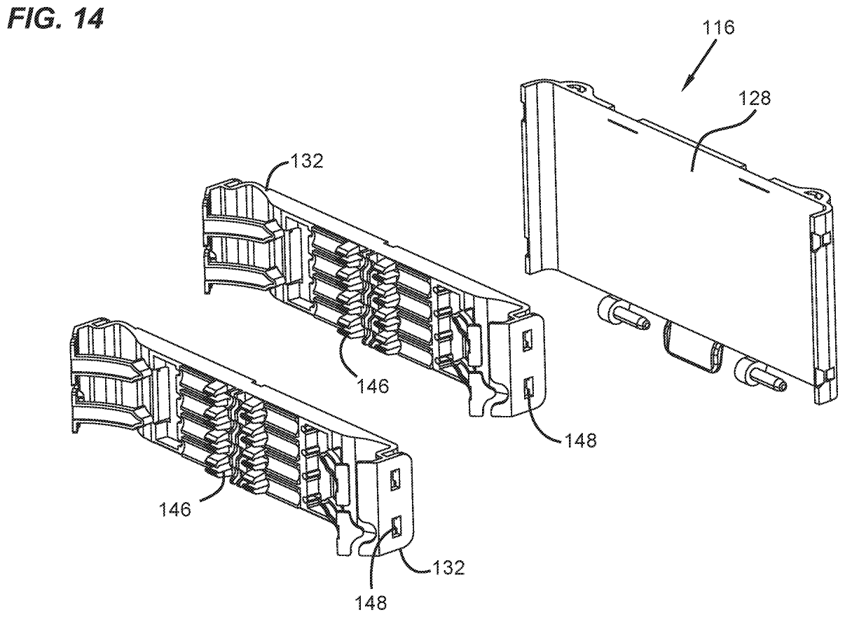

FIG. 14 shows the groove plates 132 separated from the main support plate 128. In some examples, the groove plates 132 each include individual hinges 146 so that each hinge 146 is configured to receive a tray 114. In some examples, the groove plates 132 are also configured to be removably attached to the main support plate 128 and/or the auxiliary support plate 130 to allow the user to customize the amount of groove plates 132, and therefore trays 114, in the stack 112. In some examples, the groove plates 132 are attached to the main and auxiliary support plates 128, 130 by way of a clip 148 located at either side of each groove plate 132. In some examples, the clips 148 connect the groove plate 132 to the main/auxiliary plates 128, 130. In some examples, the clips 148 can be operated to quickly remove or secure each groove plate 132 to the main/auxiliary plates 128, 130

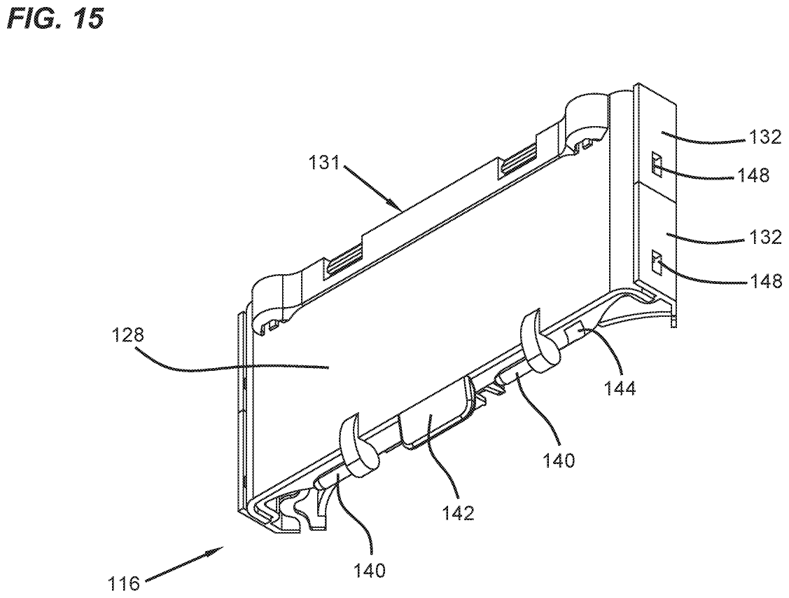

FIG. 15 shows a rear perspective view of the main support plate 128.

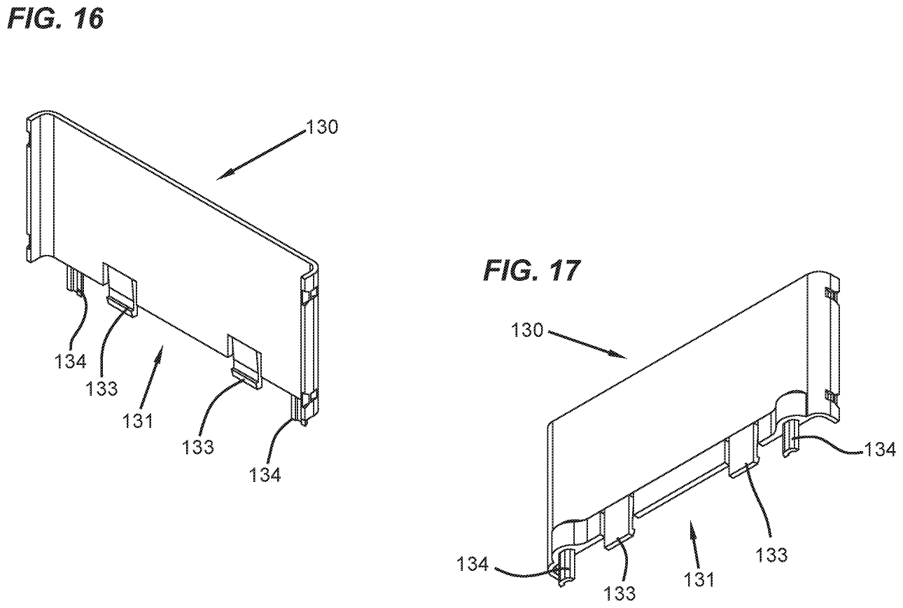

FIG. 16 shows a top perspective of the auxiliary support plate 130. FIG. 17 shows a bottom perspective view of the auxiliary support plate 130. As shown, the auxiliary support plate 130 can include mating features 131 at a bottom side. The mating features 131 include a pair of projections 134 that are configured to be received by corresponding recesses 137 of the main support plate 128. In some examples, the auxiliary support plate 130 can include projections, or projections and recesses, or just recesses, or other like mating features 131. In some examples, the mating features 131 include fasteners 133 that are configured to be attached the main support plate 128 or another additional adjacent auxiliary support plate 128. In some examples, the fasteners 133 are clips.

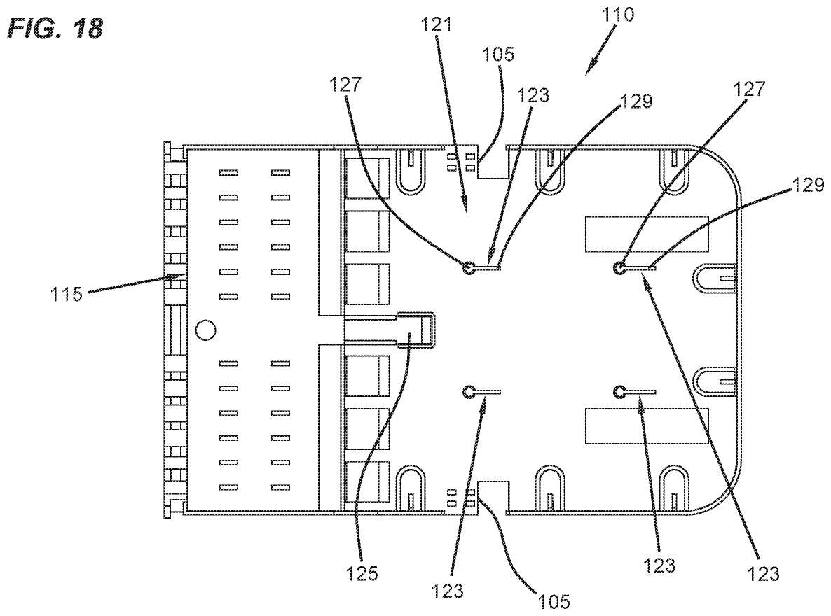

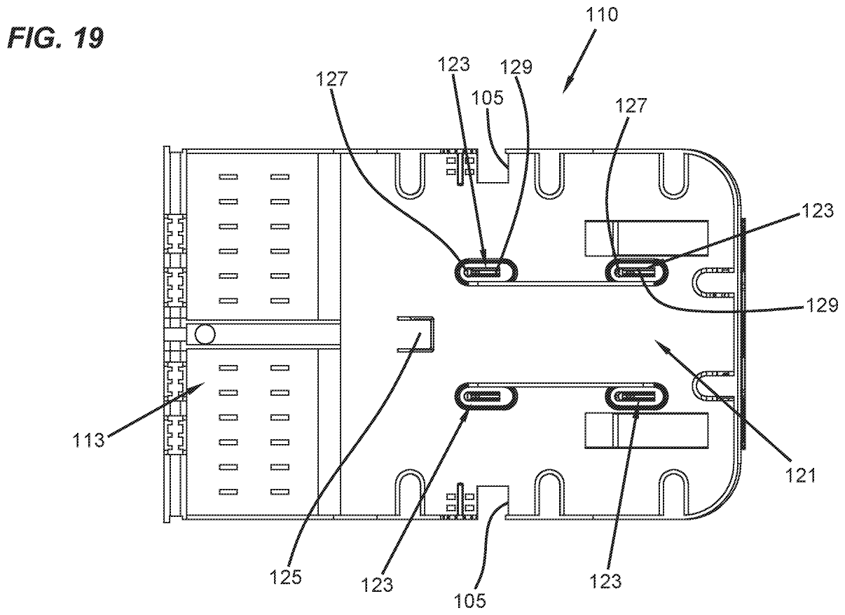

FIG. 18 shows a top view of the base tray 110, and FIG. 19 shows a bottom view of the base tray 110. The base tray 110 includes passageways 105 at either side that facilitate the passage of input fibers 107 from underneath the base tray 110 to the top side of the base tray 110, as schematically shown in FIG. 3.

As shown, the base tray 110 includes upper cable guides 115 and the interfacing features 121. In some examples, the interfacing features 121 can include a plurality of recesses 123 and a stop structure 125 that work together to receive and secure corresponding telecommunications components (e.g., the base plate 118).

The recesses 123 each have a length and a width, where the length is greater than the width. The recesses 123 can be arranged in a variety of different locations on the base tray 110. In some examples, less than all of the recesses 123 receive corresponding telecommunications components. In some examples, the recesses 123 can be projections that are received by corresponding telecommunications equipment. In the depicted examples, the base tray 110 includes four recesses 123. In some examples, the base tray 110 includes less than four recesses 123. In some examples, the base tray 110 includes greater than four recesses 123.

In some examples, the recesses 123 can have varying widths including at least a first portion 127 that is wider than a second portion 129. In some examples, the first portion 127 has a generally circular cross section.

The stop structure 125 limits, and in some examples prevents, relative movement between the base tray 110 and corresponding telecommunications components, for example, the base plate 118. In some examples, the stop structure 125 is a tab. In some examples, the tab is flexible. The stop structure 125 is generally aligned with the lengths of the recesses 123 so that the stop structure limits movement of the corresponding telecommunications components within each recess 123.

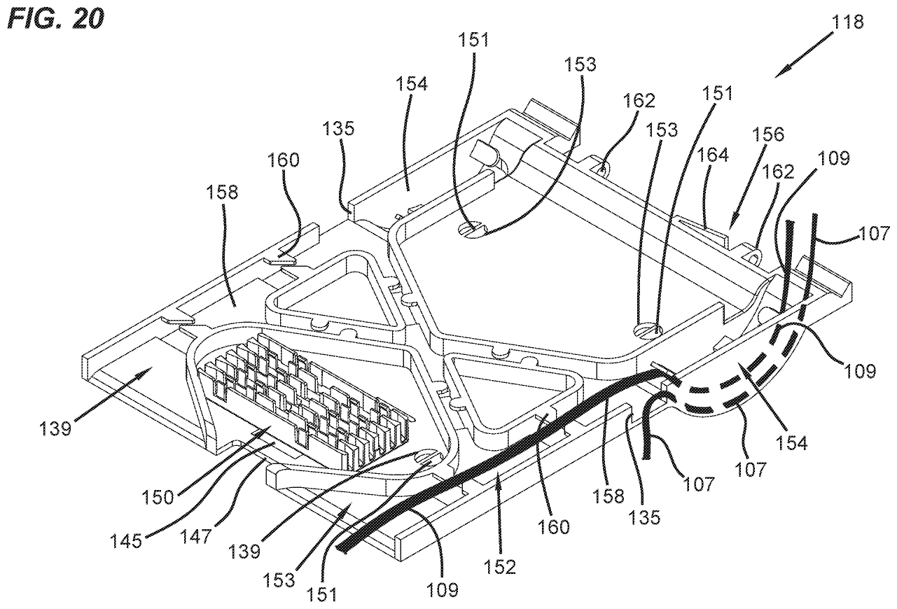

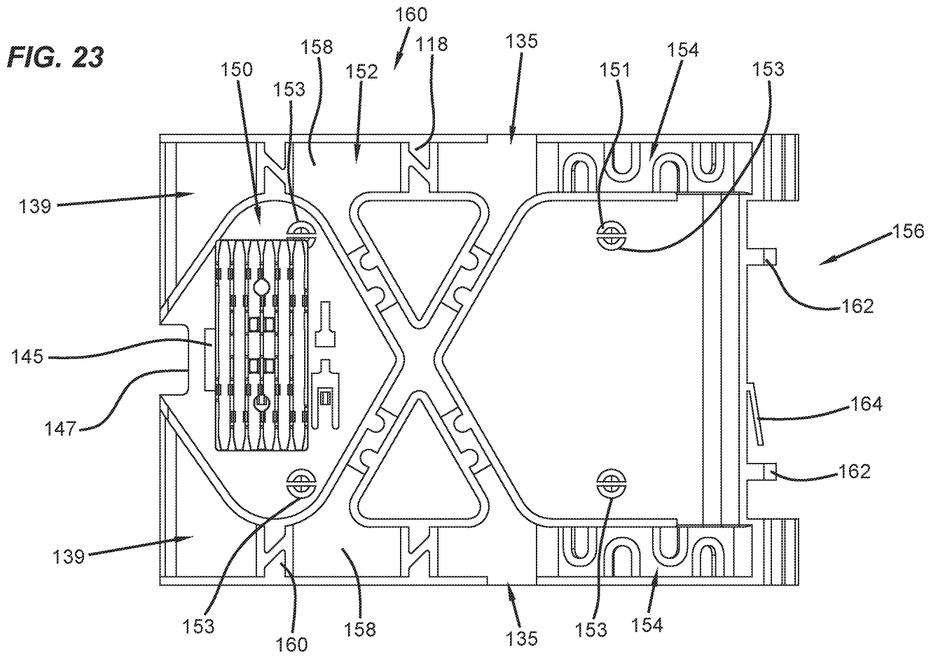

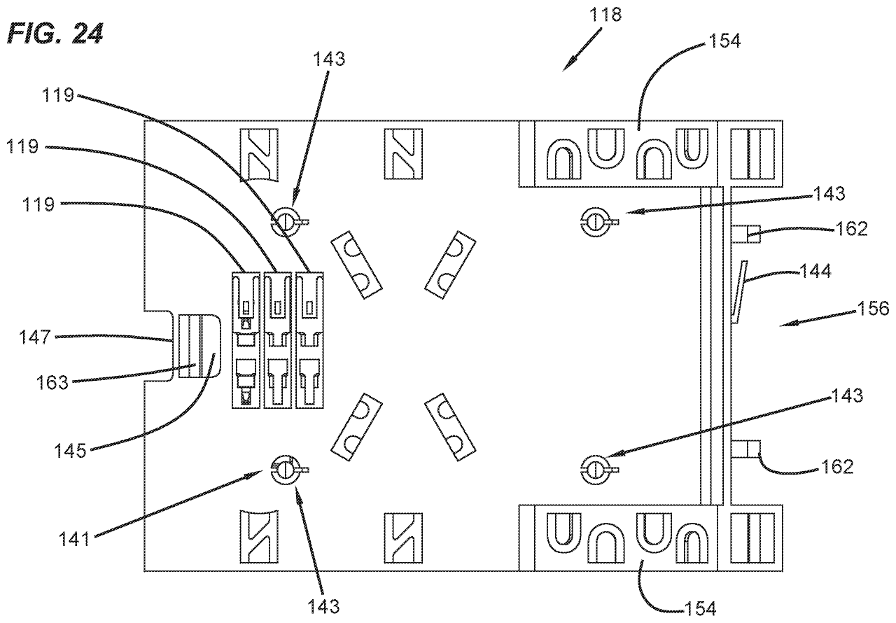

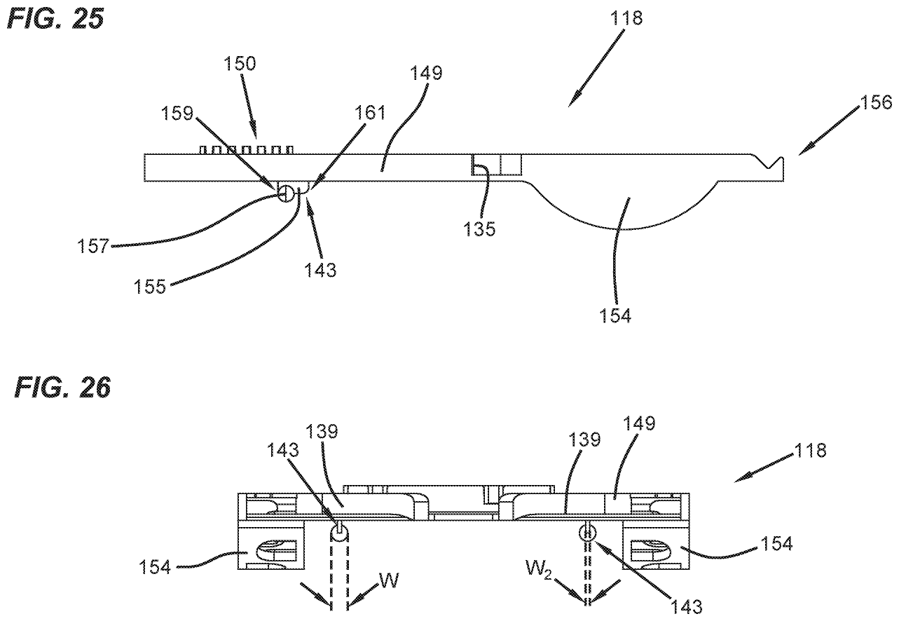

FIGS. 20-22 shown perspective views of the base plate 118. FIG. 23 shows a top view of the base plate 118 and FIG. 24 shows a bottom view of the base plate 118. FIG. 25 shows a side view of the base plate 118 and FIG. 26 shoes a front view of the base plate 118.

As noted above, the base plate 118 is configured to be attached to the tray support 116 at the hinge 124 so as to allow for relative movement between the tray support 116 and the base plate 118. In the depicted examples, the base plate 118 includes a storage area 150, fiber guides 152, a pair of fiber radius limitation channels 154, and hinge features 156.

Like the trays 114, the base plate 118 can also house a plurality of optical fiber splices at the storage area 150. In other examples, the storage area 150 can be used to store optical fiber splitters. In addition, the base plate 118 can also include fiber guides 152 to guide optical fibers. In some examples, the fiber guides 152 are channels 158 with tabs 160 to retain the optical fibers within the channel 158.

In some examples, the base plate 118 includes the pair of fiber radius limitation channels 154. In some examples, the fiber radius limitation channels 154 connect with the channels 158 on the base plate 118. In some examples, each fiber radius limitation channel 154 is adjacent the hinge features 156 of the base plate 118. In some examples, each fiber radius limitation channel 154 is an arced channel that extends away from the hinge features 156 and is configured to house optical fibers that travel to and from the trays 114 and the base plate 118. In some examples, each fiber radius limitation channel 154 extends through the base tray 110 when the base plate 118 is mounted to the base tray 110. In some examples, the fiber radius limitation channels 154 do not pass through the base tray 110 when the base plate 118 is mounted to the base tray 110. the In some examples, a single fiber radius limitation channel 154 is responsible for guiding either input fibers to the trays 114 of the stack 112 or output fibers from the trays 114 of the stack 112.

Further, the base plate 118 includes a pair of entrance passageways 135 disposed at either side of the base plate 118. The input fibers 107 enter the base plate 118 through the entrance passageways 135, travel within the fiber radius limitation channels 154 and toward the hinge features 156. The input fibers 107 then travel to the trays 114 positioned on the tray support 116. Also shown, output fibers 109 travel back through the fiber radius limitation channels 154, within the fiber guides 152 of the base plate 118, before exiting the base plate 118 at an exit passageway 139.

The hinge features 156 are configured to mate with the hinge features 138 of the main support plate 128 to form the hinge 124. In the depicted example, the hinge features 156 of the base plate 118 include a pair of apertures 162 that are sized and shaped to receive the projections 140 of the main support plate 128.

In the depicted example, the hinge features 156 also include a main plate retention element 164. In some examples, the main plate retention element 164 is a clip that is configured to interface with the main support plate 128 of the tray support 116 to secure the main support plate 128 to the base plate 118 and to prevent unintended removal of the projections 140 from the apertures 162. In some examples, the main plate retention element 164 can then be operated to detach the main support plate 128 from the base plate 118.

The hinge features 156 of the base plate 118 and the hinge features 138 of the main support plate 128 of the tray support 116 can each include a variety of combinations of the features disclosed so as to form the complete hinge 124. For example, the hinge features 156 of the base plate 118 can include projections while the hinge features 138 of the main support plate 128 of the tray support 116 can include apertures.

The hinge features 156 of the base plate 118 can also include a portion of the latch 144, shown schematically and described above, so as to aid in securing the stack 112 in at least one of the stored and access positions.

With continued reference to FIGS. 20-26, the base plate 118 includes interfacing features 141 that are configured to mate with the interfacing features 121 of the base tray 110, or other telecommunications components including the interfacing features 121. The interfacing features 141 do not require tools (i.e., toolless) to connect with corresponding interfacing features 121 to secure the base plate 118. In the depicted example, the interfacing features 141 include a plurality of projections 143, a stop aperture 145, and a stop surface 147.

The plurality of projections 143 extend from a main body 149 of the base plate 118. In some examples, each projection 143 can have identical construction. In other examples, some of the projections 143 have constructions that differ from one another in at least one of size and shape. Each projection 143 is configured to be received by a corresponding recess 123 of the interfacing features 121 of the base tray 110. In the depicted example, each projection 143 is attached to the main body 149 by way of a rib 151 and each rib 151 is secured within an aperture 153. In some examples, each projection 143 is manufactured by way of a molding process.

With reference to FIGS. 25 and 26, the projections 143 each include a guiding portion 155 and a holding portion 157. In some examples, the holding portion 157 is connected to the guiding portion 155. The holding portion 157 extends a greater distance away from the main body 149 than the guiding portion 155. Further, in some examples, the holding portion 157 also has a width W, seen in FIG. 26, that is greater than a width W2 of the guiding portion 155.

The guiding portion 155 extends along a length that is greater than a width, between a first end 159 and a second end 161. In some examples, the guiding portion 155 guides movement of each projection 143 within the respective mated recess 123 of the base tray 110. In some examples, the guiding portion 155 slides along a sliding axis aligned with its length. In some examples, the guiding portion 155 slides in a sliding direction within its mated recess 123. In some examples, the guiding portion 155 is configured to slide within the second portion 129 of the each recess 123 of the base tray 110. In some examples, the guiding portion 155 can be an extension of the rib 151. In some examples, the guiding portion 155 is a fin.

The holding portion 157 is configured to fit within the first portion 127 of the recess 123 of the base tray 110. As shown, the holding portion 157 of each recess is positioned at the first end 159 of the guiding portion 155. In some examples, the holding portion 157 is attached to the guiding portion 155. In other examples, the holding portion 157 is separated from the guiding portion 155. In some examples, the holding portion 157 has a generally spherical shape. However, it is considered within the scope of the present disclosure, that the holding portion 157 can have a variety of different shapes.

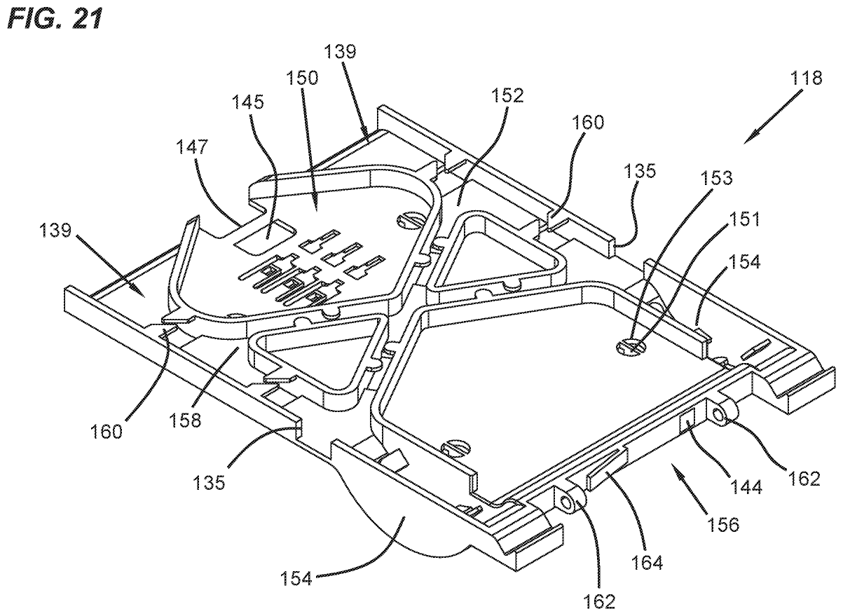

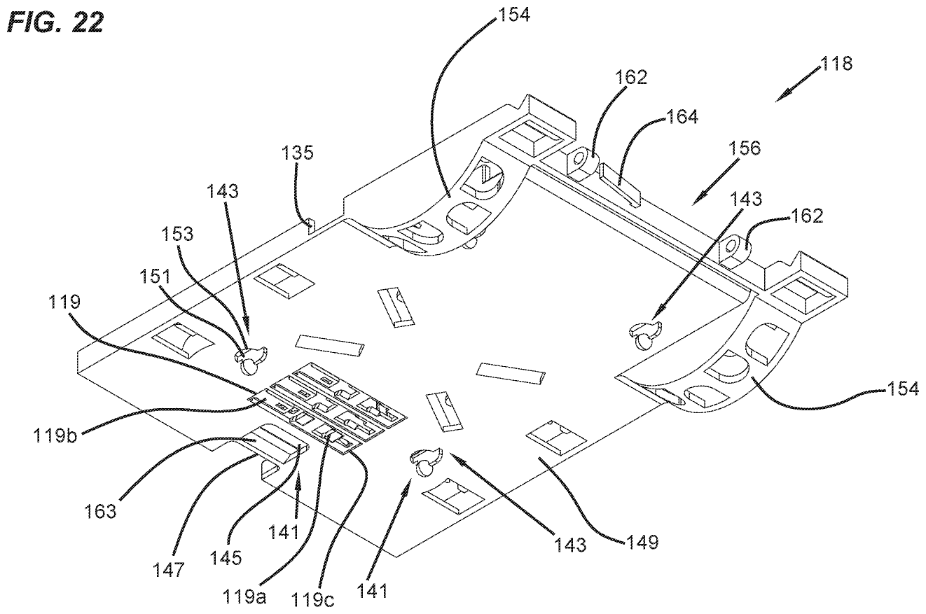

The stop aperture 145 is configured to temporality receive the stop structure 125 of the base tray 110 as the base plate 118 is connected to the base tray 110. In some examples, the stop aperture 145 is sized to accommodate the size of the stop structure 125. In some examples, the base plate 118 includes the stop structure 125 and the base tray 110 includes the stop aperture 145. In some examples, at least one of the stop structure 125 and stop aperture 145 includes a ramped surface 163. The ramped surface 163 allows the stop aperture 145 and the stop structure 125 to easily slide relative to one another so that the stop structure 125 can easily be removed from the stop aperture 145 during installation. In the depicted example, the stop aperture 145 includes a ramped surface 163, as can be seen in FIGS. 22 and 24.

The stop surface 147 is configured to mate with the stop structure 125 to limit relative movement between the base plate 118 and the base tray 110. The stop surface 147 can have a variety of different shapes so as to properly mate with the stop structure 125. As shown, the stop surface 147 is in a recess. In other examples, the stop surface is not in a recess.

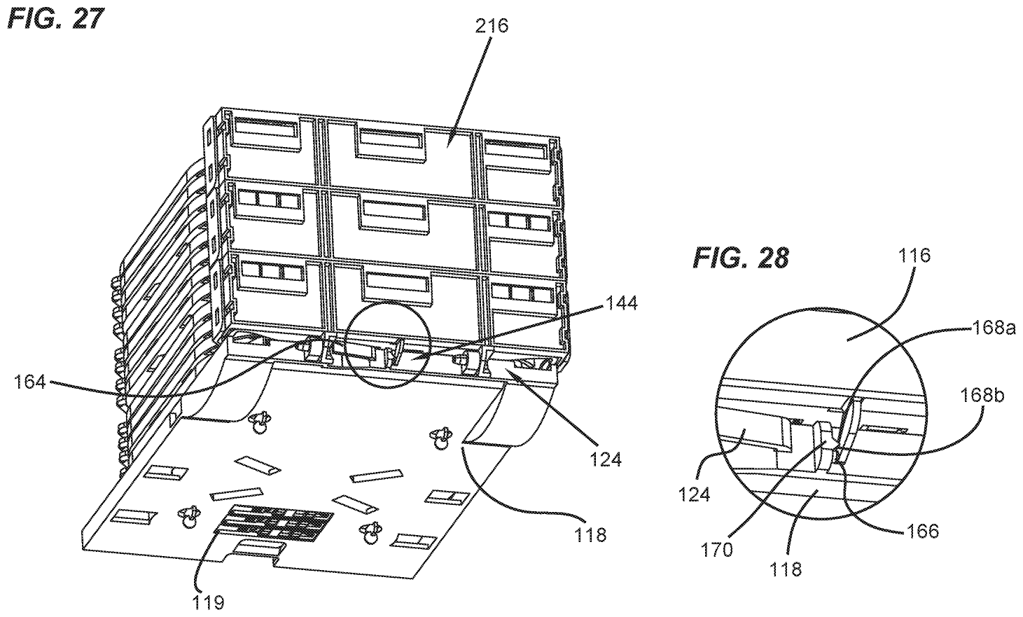

With continued reference to FIGS. 22 and 24, and to FIGS. 27 and 28, the base plate 118 can be provided with attachment features 119 to facilitate attachment of additional components onto the base plate 118. Examples of configurations for the attachment feature 119 are shown and described in Patent Cooperation Treaty (PCT) Application Serial Number PCT/US2019/17904, filed on Feb. 13, 2019, the entirety of which is incorporated by reference herein; Patent Cooperation Treaty (PCT) Application Serial Number PCT/US2019/028245, filed on Apr. 19, 2019, the entirety of which is incorporated by reference herein; and U.S. Provisional Patent Application Ser. No. 62/824,824, filed on Mar. 27, 2019, the entirety of which is incorporated by reference herein. In the example shown, two attachment features 119 are shown, with each including an aperture 119a and a deflectable member 119b for receiving corresponding dovetail-shaped interconnection features and ramp structures of a connected component (not shown). At the underside of the base plate 118, each attachment feature 119 is provided within a recessed area 119c such that the deflectable member 119b can be deflected downwardly without interference from the base tray 110. Such a configuration enables for the bottom wall of the base plate 118 to be mated directly against the bottom wall of the base tray 110 without increasing the overall height of the structure while still enabling for operation of the attachment features 119.

FIGS. 27 and 28 depict an example of the latch 144 used in connection with an example tray support 216. A portion of the latch 144 can be disposed on both the tray support 216 and the base plate 118. The latch 144 includes a first projection 166 that is configured to travel on a pair of ramped surfaces 168a, 168b of a second projection 170. For example, when in the access position, the first projection 166 is in contact with the ramped surface 168b. When the user moves the stack 112 to the stored position, the first projection 166 travels along the ramped surface 168b to the ramped surface 168a. In some examples, the tray support 116 can also move at least partially laterally as the tray support 116 is moving from the stored position to the access position. In some examples, the latch 144 can be at least partially flexible. FIG. 27 depicts the tray support 116 is secured in the stored position.

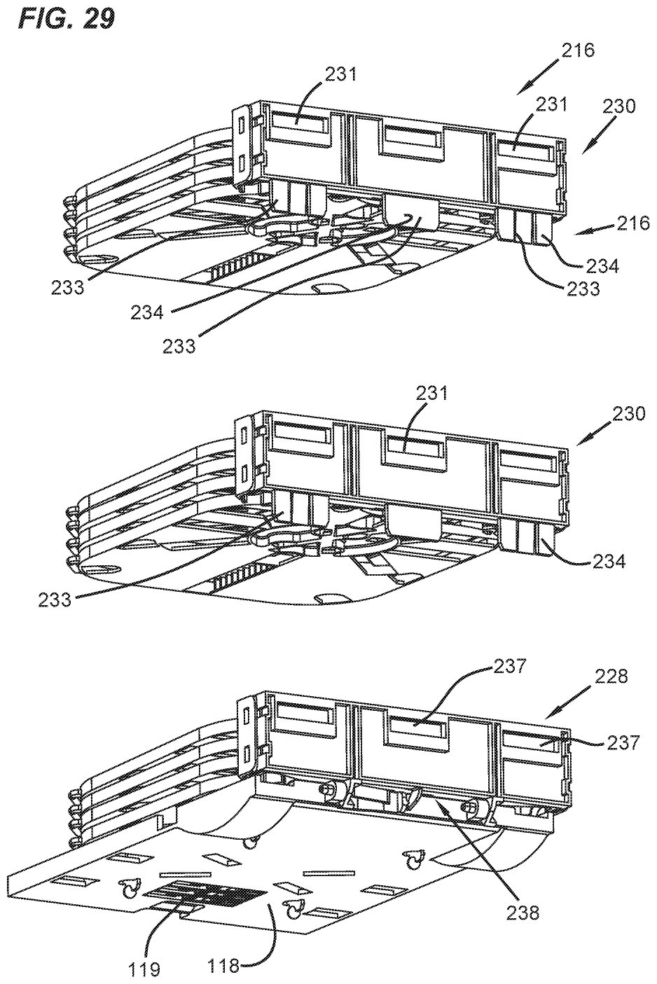

FIG. 29 shows the tray support 216 in a partially exploded view. Like the tray support 116 described above, the tray support 216 includes a main support plate 228 and auxiliary support plates 230. In some examples, the main support plate 228 and auxiliary support plates 230 are substantially similar to the main support plate 128 and auxiliary support plates 130, described above. As shown, the main support plate 228 includes hinge features 238 and recesses 237. The auxiliary support plate 230 includes projections 234 and fasteners 233. In the depicted example, the auxiliary support plate 230 also includes additional recesses 231 that are configured to receive the projections 234 of adjacent auxiliary plates 230. In some examples, the fasteners 233 are clips. In other examples, the fasteners 233 are projections that use friction to retain the auxiliary plate 230 in place. In some examples, the fasteners 233 are the projections 234.

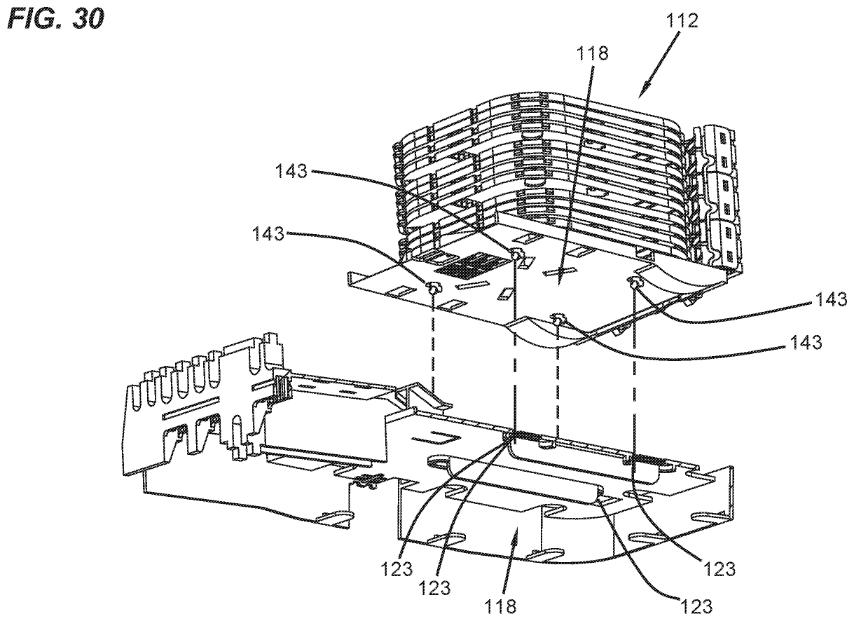

FIG. 30 depicts a schematic perspective view of a partially sectioned base tray 110 as the base plate 118 is prepared to be fastened to the base tray 110. As shown, the projections 143 of the base plate 118 are aligned with the recesses 123 of the base tray 110.

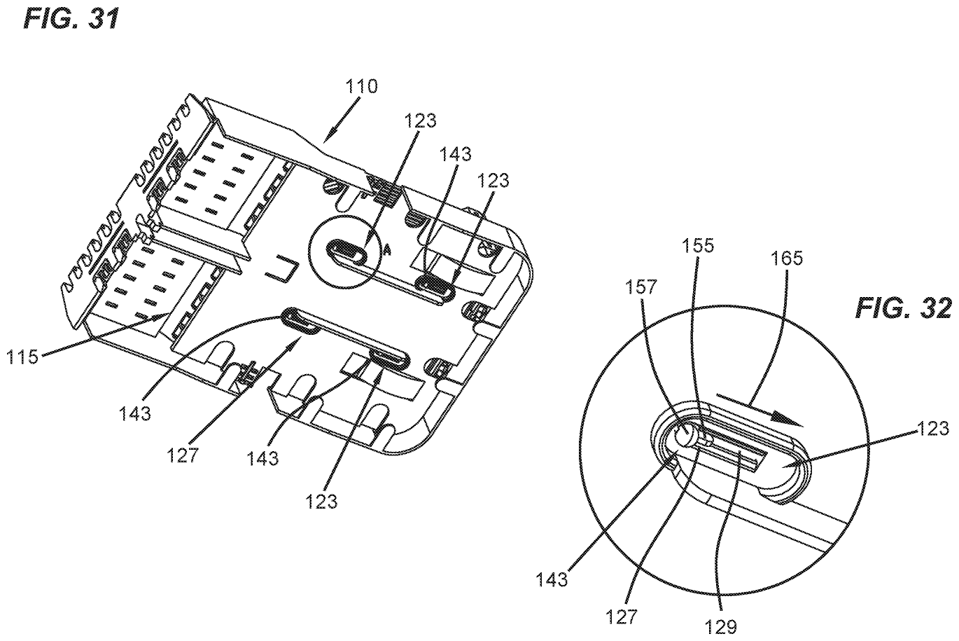

FIG. 31 shows an underside perspective view of the base tray 110 with the base plate 118 mated thereto in a non-fixed position. As shown in FIG. 32, each the projection 143 is positioned within a recess 123. Specifically, when in the non-fixed position, the holding portion 157 of the projection 143 has passed through the first portion 127 of the recess 123 and the guiding portion 155 of the projection 143 is positioned within the second portion 129 of the recess 123. In some examples, indicia 165 (e.g., an arrow) indicates the sliding direction the base plate 118 must be slid with respect to the base tray 110 so that the base tray 110 and base plate 118 become latched together in the fixed position.

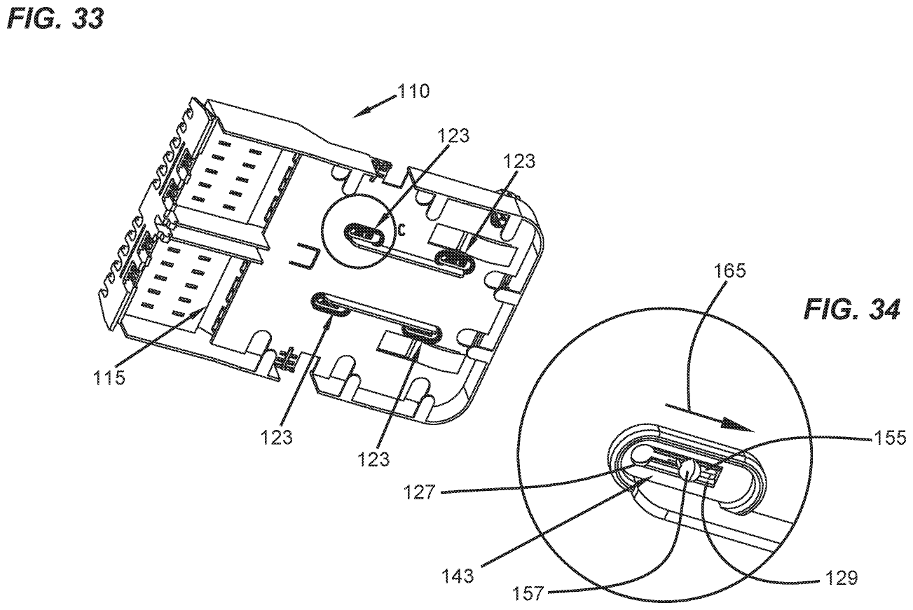

FIG. 33 shows an underside perspective view of the base tray 110 with the base plate 118 mated thereto in a fixed position. As shown in FIG. 32, each projection 143 is positioned within a recess 123. When in the fixed position, the holding portion 157 of the projection 143 is positioned under the second portion 129 of the recess 123 and the guiding portion 155 of the projection 143 is positioned within the second portion 129 of the recess 123. Because the holding portion 157 has the width W that is greater than the width W2 of the second portion of the recess 123, the holding portion 157 cannot be removed from the recess 123 by an upward motion. The holding portion 157 can only be removed from the recess 123 if the projection 143 is slid back to the non-fixed position where the holding portion 157 and the first portion 127 of the recess 123 are aligned. Therefore, the holding portion 157 holds the projection 143 within the recess and prevents removal from the recess 123 without sliding the projection 143 within the recess 123.

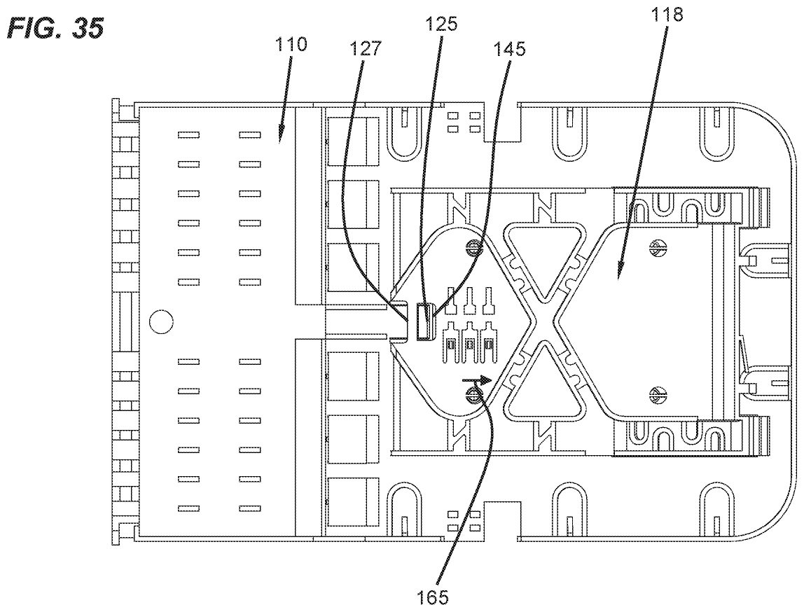

FIG. 35 shows a top view of the base plate 118 and the base tray 110 mated and in the non-fixed position. In the non-fixed position, the stop structure 125 is positioned with the stop aperture 145 so that, when the base plate 118 is first mated with the base tray 110, the base plate 118 can be positioned flat against the base tray 110. Without the stop aperture, the stop structure 125 would contact the base plate 118, causing interference and an angled relative position. To fix the base tray 110 and base plate 118 with one another, the base plate 118 is slid in the sliding direction, as shown by the indicia 165.

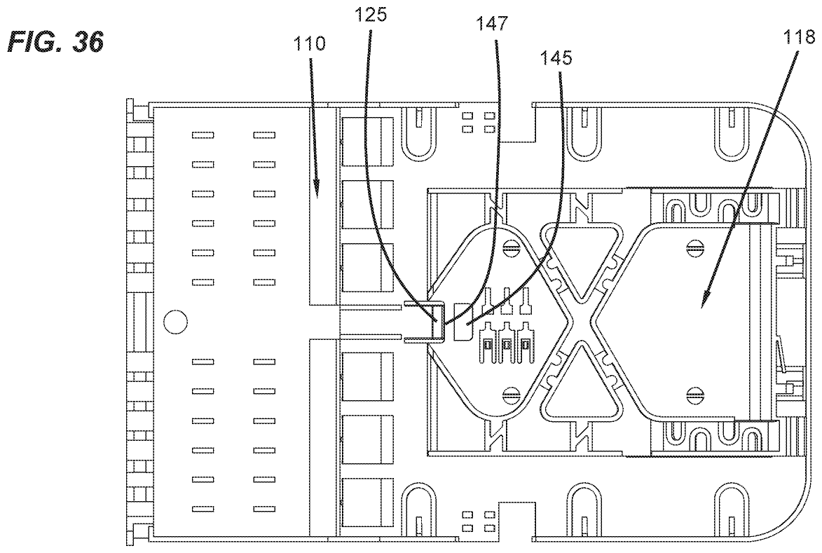

FIG. 36 shows a top view of the base plate 118 and the base tray 110 mated and in the fixed position. In the fixed position, the stop structure 125 interfaces with the stop surface 147 to limit relative movement of the base plate 118 and the base tray 110. In some examples, the stop structure 125 limits movement of the projections 143 within the recesses 123. As the base plate 118 moves from the non-fixed position to the fixed position, the base plate 118 moves the stop aperture 145 so that the stop structure 125 is removed from the stop aperture 145 and into contact with the stop surface 147.

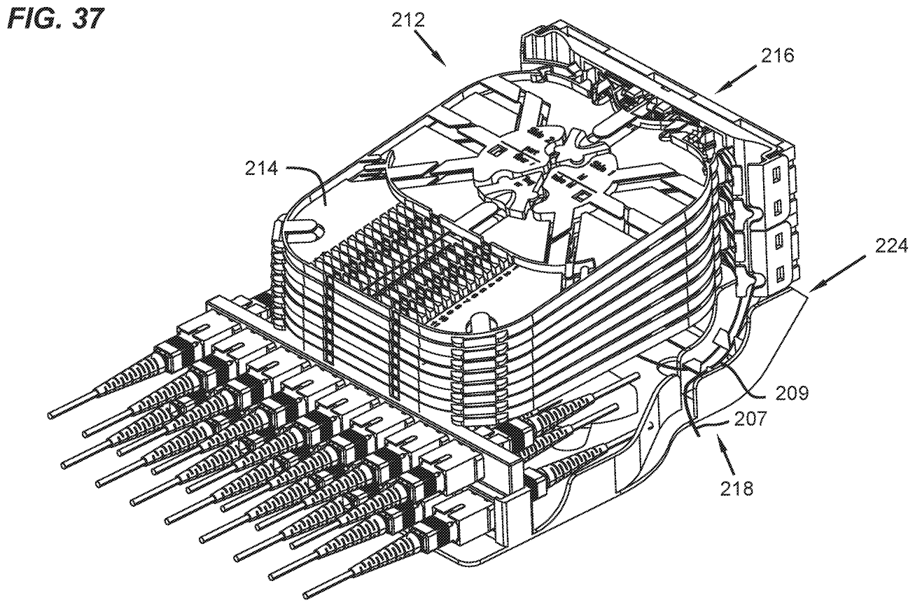

FIG. 37 shows an example stack 212 attached to a module 218, according to another example of the present disclosure. The stack 212 is substantially similar to the stack 112 described above and the stack 212 can be moveable with respect the module via a hinge 224. The stack 212 include trays 214 mounted to the tray support 216. The tray support 216 is connected to the module 218 at the hinge 224, and, like the stack 112 described above, the stack 212 can move about the hinge 224 to allow the stack 212 to move to the access position. Input fibers 207 and output fibers 209 travel in a similar path as input fibers 107 and 109. In some examples, the output fibers 209 can be connectorized. In some examples, the portions of the module 218 do not extend through the base tray 110.

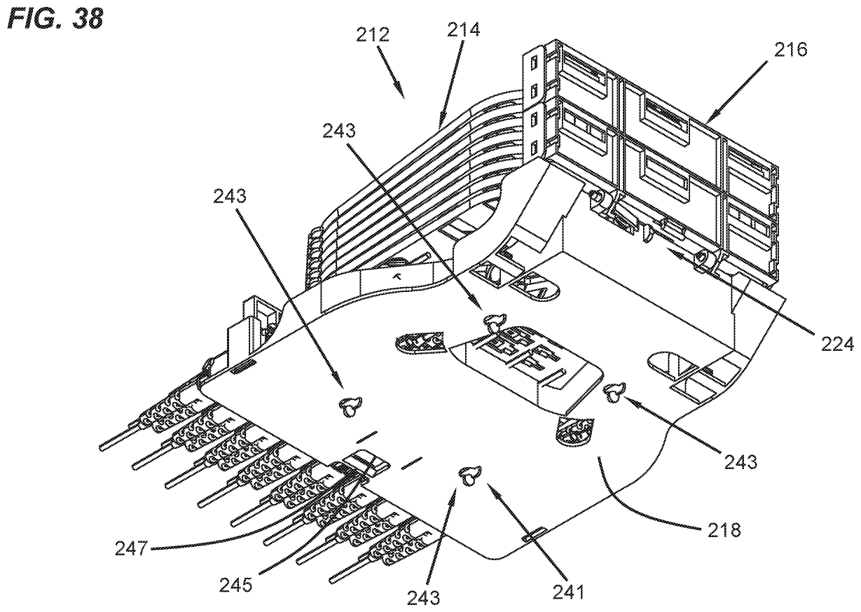

FIG. 38 shows a bottom perspective view of the module 218 including the tray support 216 and trays 214. As shown, the module 218 includes interfacing features 241, which are substantially similar to the interfacing features 141 described above. Specifically, the module 218 includes a plurality of projections 243, a stop aperture 245, and a stop surface 247. Like the base plate 118 described above, the interfacing features 241 are configured to interface and secure the module 218 to telecommunications components with corresponding interfacing features. For example, the interfacing features 241 can mate with the interfacing features 121 of the base tray 110 so as to secure the module 218 to the base tray 110.

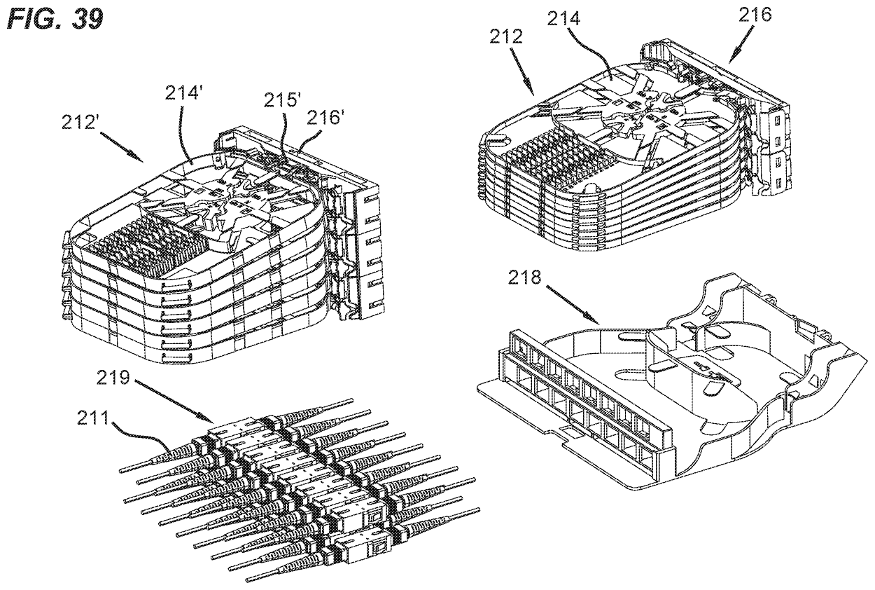

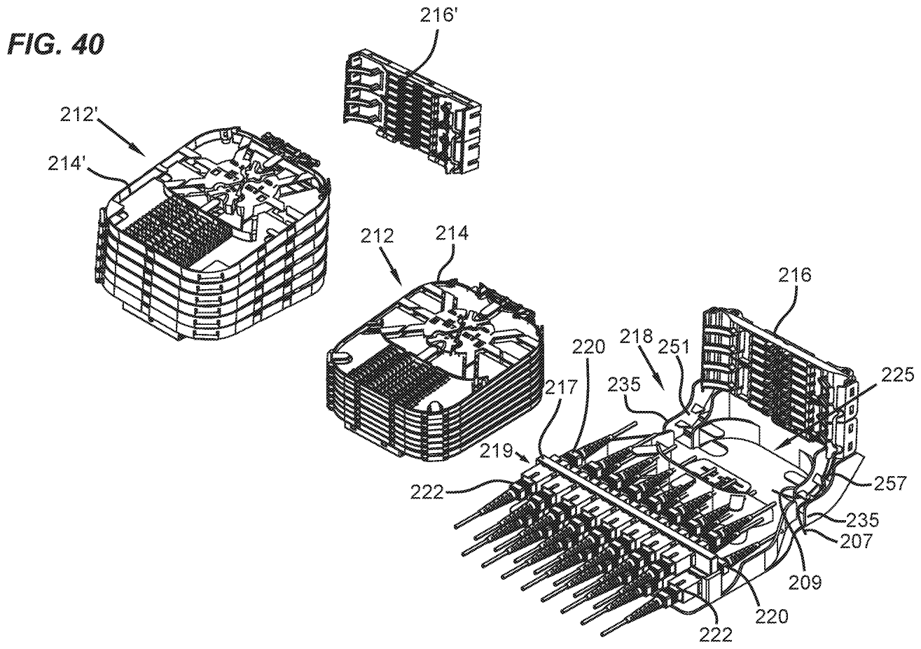

FIG. 39 shows the stack 212 partially exploded. As shown, the module 218 can include a patch panel 219 to facilitate connecting output fibers 209 with particular customer fibers. FIGS. 39 and 40 also show a second stack 212′ with trays 214′ and tray supports 216′ that are configured generally similar to the stack 212, but with a different hinge mechanism 215′ between the trays 214′ and the tray supports 216′, in comparison the hinge mechanism 215 shown for the stack 212. The configuration of the hinge mechanism 215′ is usable with any of the configurations presented herein for providing a hinged connection between the trays and the tray supports.

FIG. 40 shows the patch panel 219 installed on the module 218. The patch panel 219 includes a plurality of ports 217 configured to receive a plurality of inputs 220 and a plurality of outputs 222. In some examples, inputs 220 are provided at one side of the patch panel 219 and outputs 222 are provided at the opposite side of the patch panel 219. The inputs 220 can be provided by the output fibers 209 from the trays 214. As noted above, the output fibers 209 can be pre-connectorized or the output fibers 209 can be spliced to a connectorized cable at an interior 225 of the module 218. In some examples, a cover covers the interior 225 of the module 218. In some examples, the output fibers 209 from each tray 214 can enter a fiber optic splitter prior to providing inputs 220 to the patch panel 219, thereby providing a split connection. In other examples, the output fibers 209 can provide a point-to-point connection to the inputs 220 of the patch panel 219.

Depending on the application, a user can then plug a connectorized output 222 into the patch panel 219 and provide service. The patch panel 219 allows the user to provide the plurality of inputs 220 at installation and the freedom to provide outputs as needed over time. For example, a single output 222 can be connected to the patch panel 219 while there are a plurality of inputs 220 connected to the patch panel. When another output 222 is needed, the user can plug another connectorized output 222 into the ports 217 of the patch panel 219 to provide another output. This allows for easy scaling.

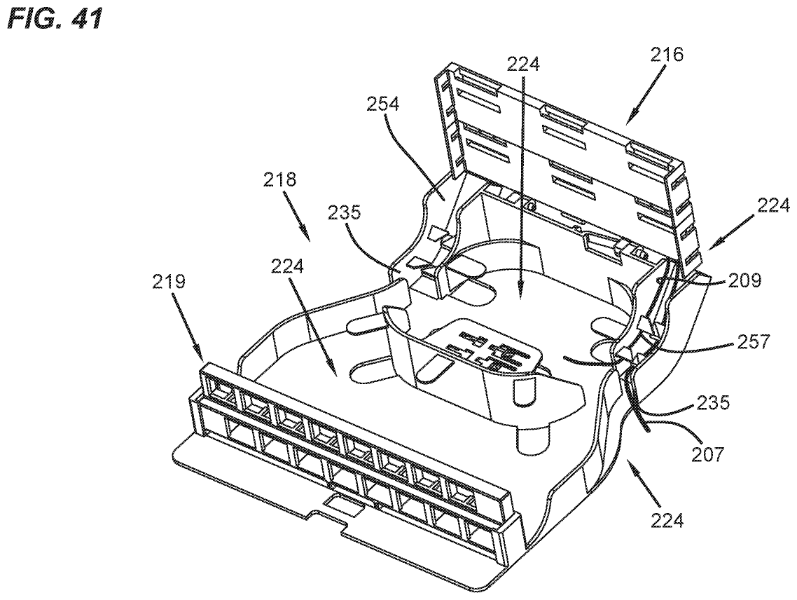

As shown in FIGS. 40-42, the module 218 can also include entrance passageways 235 at either side of the module 218. The entrance passageways 235 are substantially similar to the entrance passageways 135, described above, and are configured to receive the input fibers 207. The input fibers 207 can pass through the entrance passageways 235 and into radius limitation channels 254, which are substantially similar to the radius limitation channels 154 described above, and to the trays 214. Output fibers 209 can pass back through the radius limitation channels 254 before traveling to the interior 225. In some examples, when fixed to the base tray 110, the radius limitation channels 254 do not extend through the base tray 110.

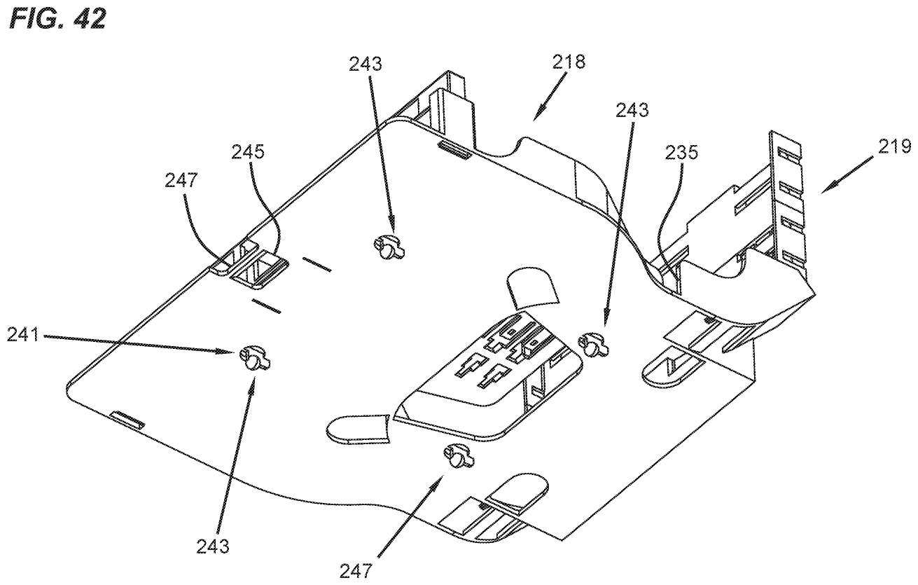

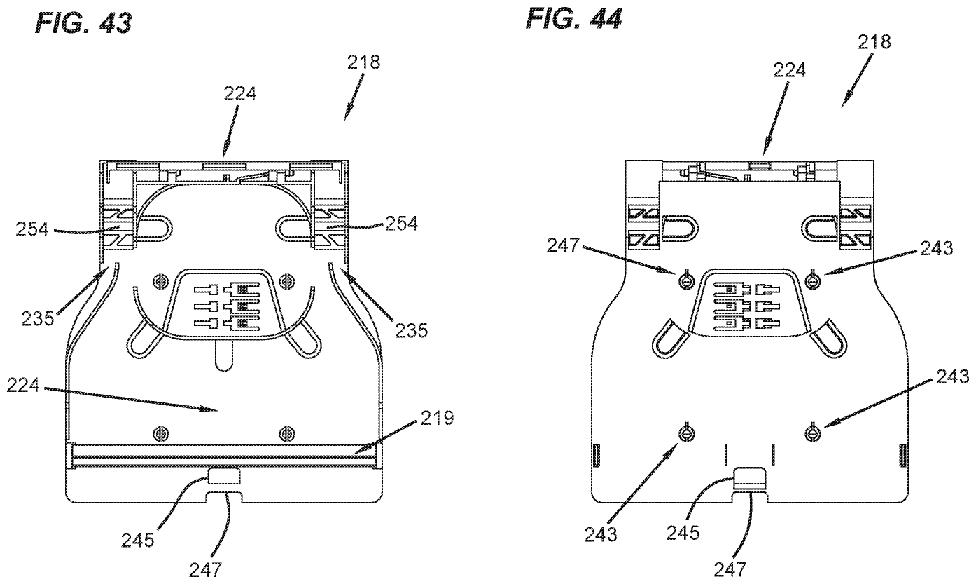

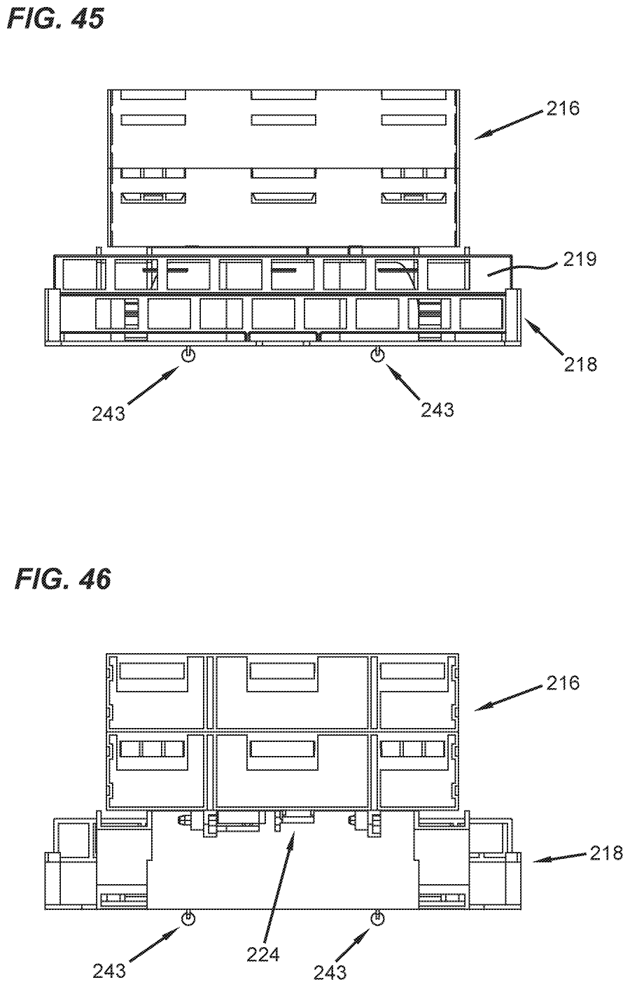

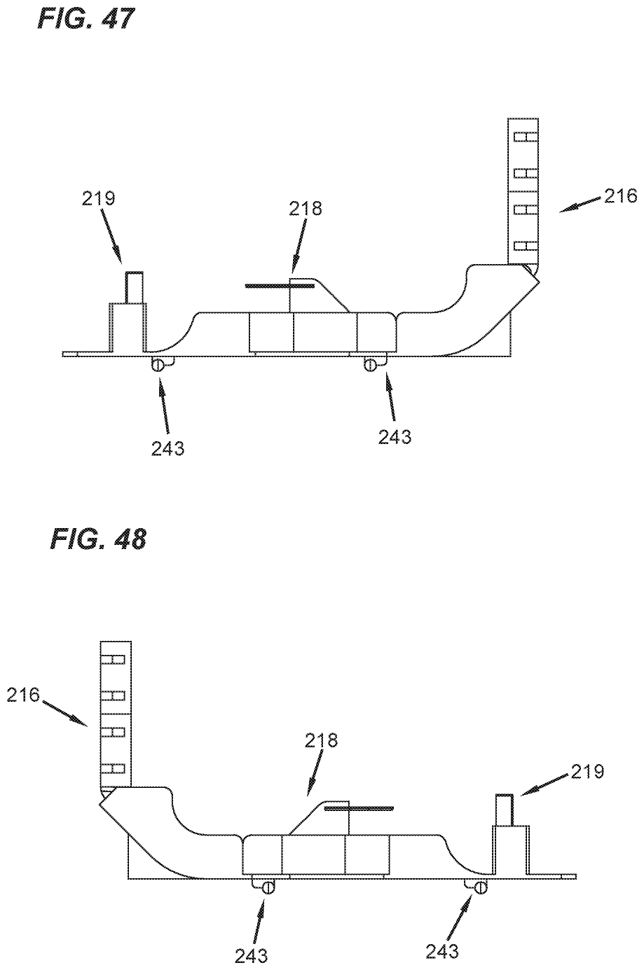

FIG. 42 shows a bottom perspective view of the module 218 and tray support 216 without trays or fibers. FIG. 43 shows a top view of the module 218, and FIG. 44 shows a bottom view of the module 218. FIG. 45 shows an end view of the module 218, and FIG. 46 shows another end view of the module 218. FIG. 47 shows a side view of the module 218, and FIG. 48 shows another side view of the module 218.

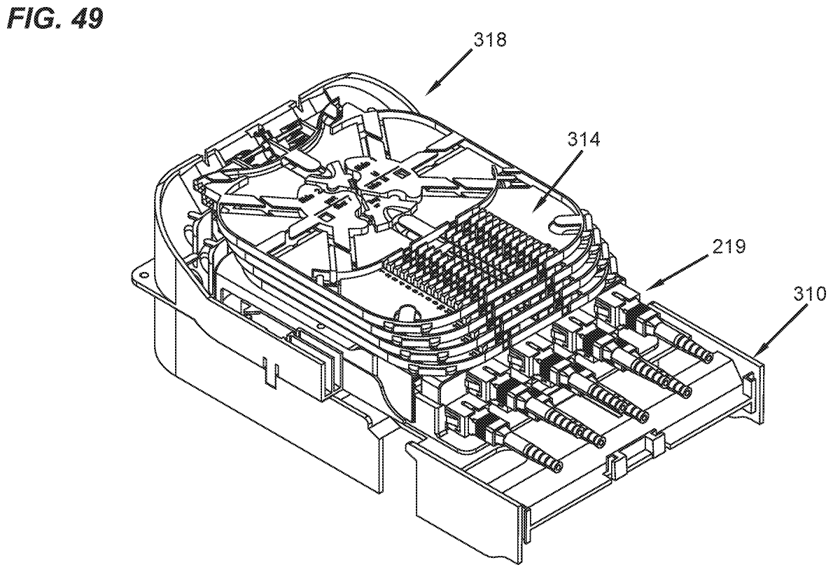

FIG. 49 shows a perspective view of a non-hinged module 318 connected to a base tray 310.

The module 318 can include a plurality of trays 314. The module 318 can also include a patch panel 319, which can be substantially similar to the patch panel 219 described above. The module 318 is configured to receive input fibers, rout the input fibers to the trays 314, and pass output fibers from the trays 314 to the patch panel 319 for output connections.

The base tray 310 is substantially similar to the base tray 110, described above. The base tray 310 is configured to be placed in a closure and is used to aid in organizing input and output cables.

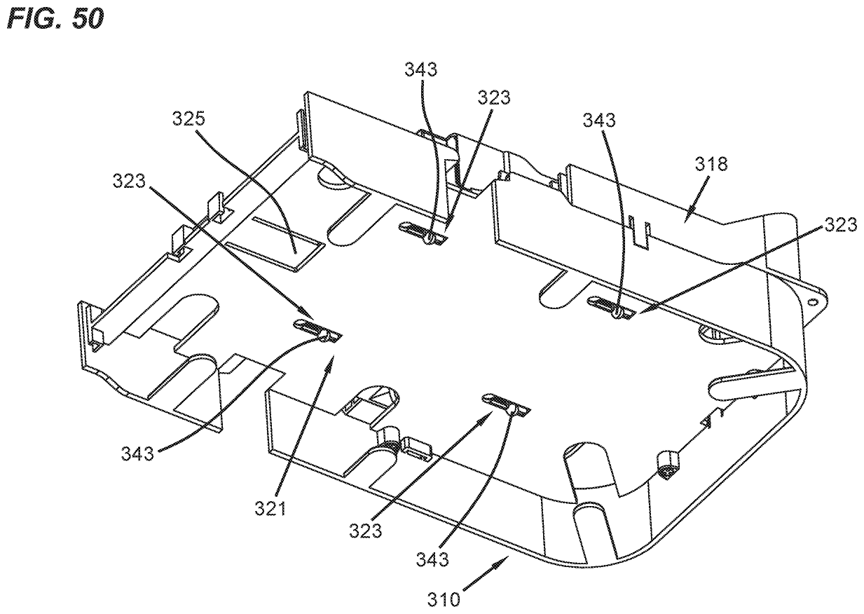

FIG. 50 shows an underneath perspective view of the base tray 310 with the module 318 connected thereto in a fixed position.

Like the base tray 110 above, the base tray 310 include interfacing features 321, which are substantially similar to interfacing features 121. The interfacing features 321 include a plurality of recesses 323 and a stop structure 325 that work together to receive and secure corresponding telecommunications components (e.g., the base plate 118, module 218, or module 318). Specifically, the plurality of recesses 323 receive a plurality of projections 343 of the module 318 and the stop structure 325 interfaces with a stop aperture 345 and stop surface 347 of the module 318.

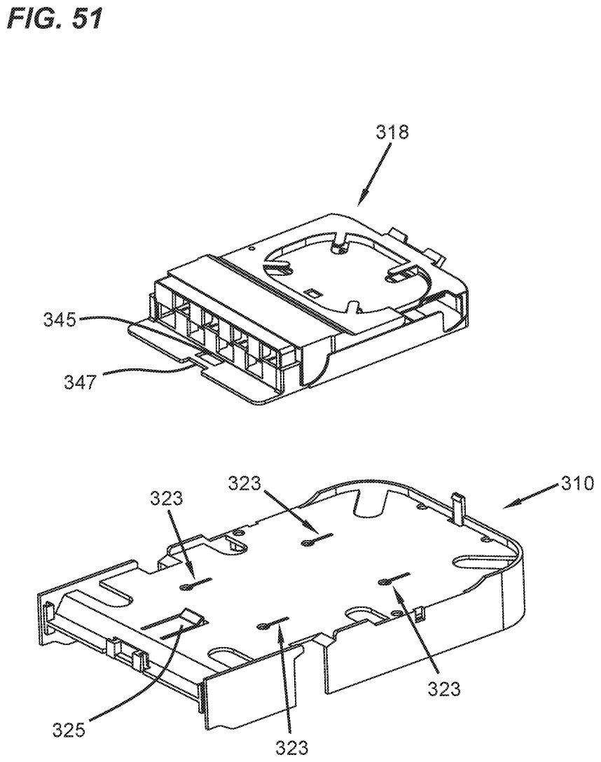

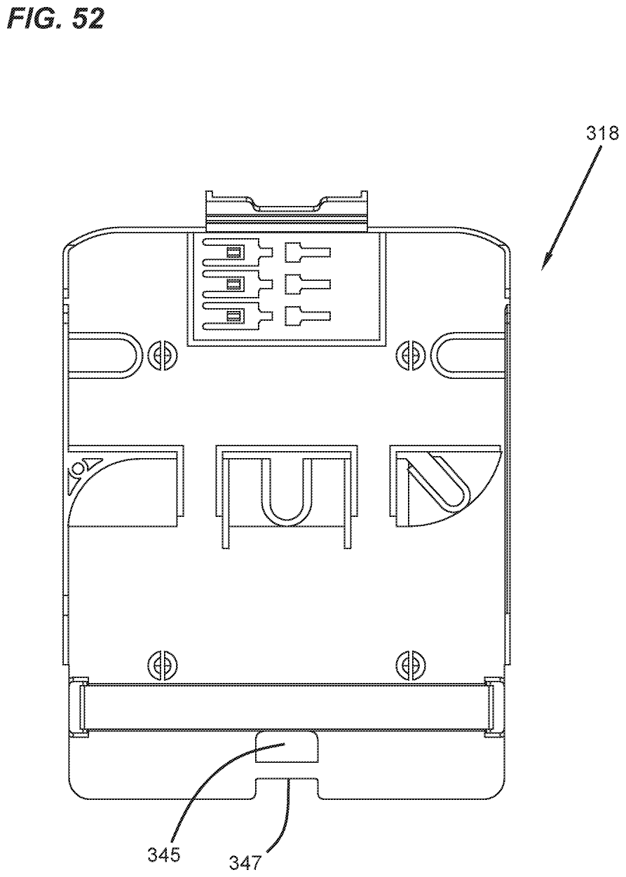

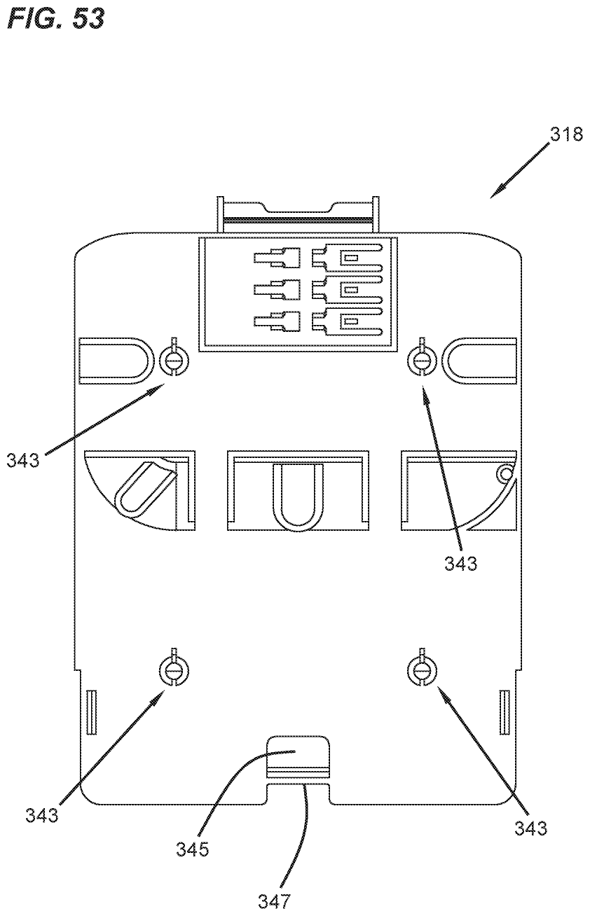

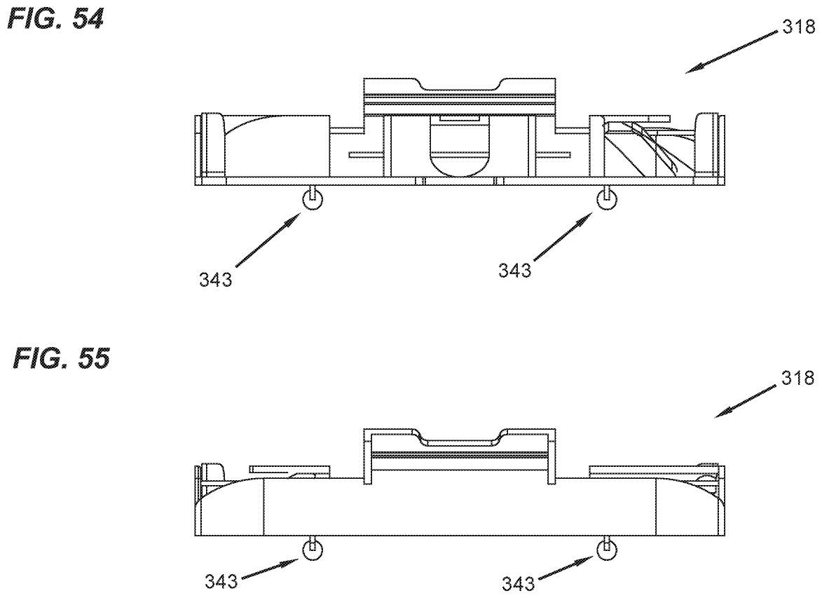

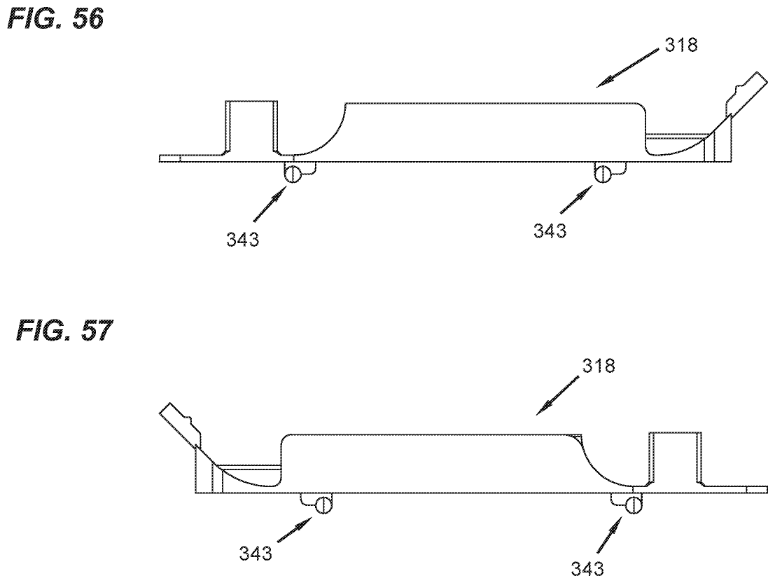

FIG. 51 shows the module 318 separated from the base tray 310. FIG. 52 shows a top view of the module 318, and FIG. 53 shows a bottom view of the module 318. FIG. 54 shows an end view of the module 318, and FIG. 55 shows another end view of the module 318. FIG. 56 shows a side view of the module 318, and FIG. 57 shows another side view of the module 218.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A telecommunication component comprising:
a cover sized and shaped to cover a stack area having an outer boundary; and
a stack including a plurality of optical fiber splice trays pivotally connected to a tray support, wherein the stack is movable between a stored position and an access position,
wherein, when the stack is in the stored position, the plurality of optical fiber splice trays is positioned within the outer boundary of the stack area, and wherein, when the stack is in the access position, at least one of the plurality of optical fiber splice trays is positioned at least partially outside of the outer boundary of the stack area.

2. The telecommunication component of claim 1, wherein the tray support includes at least one groove plate removably secured thereto.

3. The telecommunication component of claim 1, wherein at least one of the tray support and a base includes a stop, wherein the stop is configured to interface with the corresponding tray support and base to limit further rotation of the tray support past the access position.

4. The telecommunication component of claim 1, further comprising a latch, wherein the latch secures the tray support in at least one of the stored position and the access position.

5. The telecommunication component of claim 1, wherein the plurality of optical fiber splice trays of the stack contain differently sized trays.

6. The telecommunication component of claim 1, wherein the plurality of optical fiber splice trays of the stack contain identically sized trays.

7. The telecommunication component of claim 1, wherein when in the access position, the plurality of optical fiber splice trays of the stack are positioned in a staggered configuration.

8. The telecommunication component of claim 1, wherein when in the stored position, the plurality of optical fiber splice trays of the stack are positioned in a vertically aligned configuration.

9. The telecommunication component of claim 1, wherein the tray support is modular.

10. The telecommunication component of claim 1, wherein the base is a base plate attached to a closure base.

11. The telecommunication component of claim 1, wherein the base includes at least one fiber radius limitation channel adjacent a hinge configured to receive the tray support.

12. The telecommunication component of claim 1, wherein the at least one fiber radius limitation channel is adjacent a hinge, the hinge being configured to receive the tray support.

13. The telecommunication component of claim 1, wherein the at least one fiber radius limitation channel is an arced channel that extends away from the hinge, wherein the at least one fiber radius limitation channel is configured to house optical fibers that travel to and from the plurality of optical fiber splice trays and the base.

14. The telecommunication component of claim 1, wherein the base includes at least one splitter storage location that is configured to store an optical fiber splitter.

15. A method of operating a telecommunications system, the method comprising:
providing a cover removably attached to a base;
providing a tray support rotatably fixed about a hinge to the base, the tray support being movable between a stored position and an access position;
providing a plurality of optical fiber splice trays rotatably connected to the tray support, wherein when the tray support is in the stored position, the plurality of optical fiber splice trays occupy a stack area defined by an outer boundary;
removing the cover from the base;
moving tray support to the access position after removing the cover, wherein, when in the access position, at least one of the plurality of optical fiber splice trays is positioned at least partially outside of the outer boundary of the stack area.

16. The method of claim 15, wherein, when the tray support is in the stored position, the plurality of optical fiber splice trays are in an aligned stacked arrangement.

17. The method of claim 15, wherein, when the tray support is in the access position, the plurality of optical fiber splice trays are in a staggered stacked arrangement.

18. The method of claim 15, wherein, when moving the tray support to the access position, the tray support is moved away from the base.

19. The method of claim 15, further comprising, when the tray support is moved to the access position, pivoting at least one of the plurality of optical fiber splice trays with respect to the tray support.

20. A telecommunication component comprising:
a base including a hinge;
a stack including a plurality of optical fiber splice trays pivotally connected to a tray support, the tray support being connected to base via the hinge, wherein the stack is movable between a stored position and an access position,
wherein, when the stack is in the stored position, the plurality of optical fiber splice trays is positioned within the outer boundary of the stack area, and wherein, when the stack is in the access position, at least one of the plurality of optical fiber splice trays is positioned at least partially outside of the outer boundary of the stack area.
